(19) United States
(12) Patent Application Publication
(10) Pub. No.: US 2024/0125689 A1
(43) Pub. Date: Apr. 18, 2024

(54) METHODS FOR CLASSIFYING PARTICLES USING IMAGES BASED ON FILTERED LAYERS AND MACHINE LEARNING MODELS AND SYSTEMS FOR SAME

(71) Applicant: Becton, Dickinson and Company, Franklin Lakes, NJ (US)

(72) Inventor: James Almarode, Lebanon, OR (US)

(21) Appl. No.: 18/226,542

(22) Filed: Jul. 26, 2023

Related U.S. Application Data
(60) Provisional application No. 63/416,674, filed on Oct. 17, 2022.

(51) Int. Cl. G01N 15/14; G06T 5/00

(52) U.S. Cl. CPC G01N 15/1434; G06T 5/002; G06T 2207/20084

(57) ABSTRACT

Aspects of the present disclosure include methods, systems and non-transitory computer readable storage mediums for classifying cytometric image data using single particle, e.g., cell, images. Methods of classifying cytometric image data according to certain embodiments include: receiving unclassified cytometric image data, wherein the cytometric image data comprises a plurality of images corresponding to image channels, and iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data. Aspects of the present disclosure further include methods of training a model to classify cytometric image data, the method comprising: receiving flow cytometric data comprising unclassified cytometric image data, wherein each instance of cytometric image data comprises a plurality of images corresponding to image channels, classifying each instance of the cytometric image data of the flow cytometric data to establish ground truth data, and training a model to classify cytometric image data as comprising a particle belonging to a first category of particles by modulating aspects of at least one image of the plurality of images of each instance of the cytometric image data of the ground truth data. Systems for practicing the subject methods are also provided. Non-transitory computer readable storage mediums are also described.

### CROSS-REFERENCE TO RELATED APPLICATIONS

This application claims priority to the filing date of U.S. Provisional Patent Application Ser. No. 63/416,674 filed on Oct. 17, 2022; the disclosure of which application is incorporated herein by reference.

### INTRODUCTION

Flow-type particle detection, analysis and imaging systems are useful for detecting, analyzing and imaging particles in a fluid sample. Analysis of cytometric data can play an important role in understanding populations of data by helping to classify particles into one or more types of particles, e.g., classifying cells into cell types.

The development of flow cytometry with imaging features has added new capabilities for single particle, e.g., cell identification and analysis, as demonstrated by techniques for sorting cells based on spatial image parameters calculated in real time. See, e.g., Schraivogel et al., Science 375, 315-320 (2022), incorporated herein in its entirety. Using existing tools, a flow cytometer researcher has access to scatter, fluorescent and imaging-derived parameters for performing gating, clustering and/or statistical analysis to identify particle, e.g., cell, populations.

Further, imaging flow cytometer technology has introduced an additional data set for analysis, particularly, the single cell images from which image-derived parameters may be calculated. However, not all aspects of such data, e.g., imaging features across multiple imaging channels, are fully leveraged when cytometric imaging data is analyzed according to current techniques in the art.

### SUMMARY

Therefore, the inventors have realized that there is a need for yet continued improvement in techniques for classification of particles, e.g., cells, such as, analysis techniques that leverage image features (e.g., by utilizing extra information related to features detected between multiple imaging channels) in connection with classifying particles, e.g., cells. Embodiments of the present invention satisfy this need.

Embodiments of the present invention introduce novel techniques for classifying cytometric images more effectively, in terms of accurately and consistently identifying whether a particle belongs to a category or type or classification of particles, thereby improving the usefulness of flow-type particle detection and analysis systems and data derived therefrom, such as cytometric imaging data. Further, embodiments of the present invention provide advantages by identifying populations that may be missed by traditional gating as well as speeding up the identification of populations of particles, e.g., cells, by automating the classification of particles into different types or categories or classifications (i.e., particle subtypes, particle subcategories or particle subclassifications). Existing techniques in the art involve manual gating of subpopulations using, for example, geometric gates or invoking a clustering algorithm based on predetermined parameters. Utilizing image data, i.e., cytometric image data, in the present invention enables flexible classification based on the morphology or spatial fluorescent intensity present in the image data. By preprocessing images with image processing techniques, i.e., filters or other image modulation techniques, such as, for example, blurring or smoothing an image, important information in the image data—as well as across different images—can be highlighted. The inventors have discovered that repeated, i.e., iterative, application of image modulation techniques to cytometric image data, in conjunction with application of a model, such as a machine learning model, e.g., a neural network, improves the accuracy and effectiveness of cytometric image analysis and classification techniques. Similarly, the inventors have discovered that applying image modulation techniques to cytometric image data, in connection with training a model, such as a machine learning model, e.g., a neural network, improves the accuracy and effectiveness of applying the model to classify cytometric image data.

Aspects of the present disclosure include methods of classifying cytometric image data using single particle images, e.g., single cell images. Methods of classifying cytometric image data according to certain embodiments include: receiving unclassified cytometric image data, wherein the cytometric image data comprises a plurality of images corresponding to image channels, and iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data. Aspects of the present disclosure further include methods of training a model to classify cytometric image data, the method comprising: receiving flow cytometric data comprising unclassified cytometric image data, wherein each instance of cytometric image data comprises a plurality of images corresponding to image channels, classifying each instance of the cytometric image data of the flow cytometric data to establish ground truth data, and training a model to classify cytometric image data as comprising a particle belonging to a first category of particles by modulating aspects of at least one image of the plurality of images of each instance of the cytometric image data of the ground truth data.

Aspects of the present disclosure further include systems for classifying cytometric image data. Systems for classifying cytometric image data according to certain embodiments include: a processor comprising memory operably coupled to the processor, wherein the memory comprises instructions stored thereon, which, when executed by the processor, cause the processor to: receive unclassified cytometric image data, wherein the cytometric image data comprises a plurality of images corresponding to image channels, and iteratively modulate aspects of at least one image of the plurality of images of the cytometric image data and apply a model to the modulated cytometric image data to classify the cytometric image data, wherein the model is trained to estimate the presence of a particle belonging to a first category of particles in the cytometric image data.

Aspects of the present disclosure further include non-transitory computer readable storage medium comprising instructions stored thereon for classifying cytometric image data. Non-transitory computer readable storage mediums according to certain embodiments include instructions comprising: algorithm for receiving unclassified cytometric image data, wherein the cytometric image data comprises a plurality of images corresponding to image channels, and algorithm for iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data.

### BRIEF DESCRIPTION OF THE FIGURES

The invention may be best understood from the following detailed description when read in conjunction with the accompanying drawings. Included in the drawings are the following figures:

FIGS. 1A-B depict exemplary cytometric image data in accordance with embodiments of the present invention.

FIGS. 2A-B depict flow diagrams of methods for classifying cytometric image data using single particle images according to embodiments of the present invention.

FIGS. 3A-B depict exemplary image-modulated cytometric image data in accordance with embodiments of the present invention.

FIG. 4 depicts a block diagram of a computing system according to certain embodiments.

FIGS. 5A-H depict excerpts of user interfaces of an embodiment of a computer implementation of a method according to the present invention.

### DETAILED DESCRIPTION

Aspects of the present disclosure include methods, systems and non-transitory computer readable storage mediums for classifying cytometric image data using single particle, e.g., cell, images. Methods of classifying cytometric image data according to certain embodiments include: receiving unclassified cytometric image data, wherein the cytometric image data comprises a plurality of images corresponding to image channels, and iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data. Aspects of the present disclosure further include methods of training a model to classify cytometric image data, the method comprising: receiving flow cytometric data comprising unclassified cytometric image data, wherein each instance of cytometric image data comprises a plurality of images corresponding to image channels, classifying each instance of the cytometric image data of the flow cytometric data to establish ground truth data, and training a model to classify cytometric image data as comprising a particle belonging to a first category of particles by modulating aspects of at least one image of the plurality of images of each instance of the cytometric image data of the ground truth data. Systems for practicing the subject methods are also provided. Non-transitory computer readable storage mediums are also described.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

The present disclosure provides methods for classifying cytometric image data using images of single particles, e.g., cells. In further describing embodiments of the disclosure, methods that include receiving unclassified cytometric image data, wherein the cytometric image data comprises a plurality of images corresponding to image channels, and iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data, are first described in greater detail. Next, systems to practice the subject methods are described. Non-transitory computer readable storage mediums are also described.

### Methods

As summarized above, methods of classifying cytometric image data using single particle, e.g., cell, images are provided. Methods of classifying cytometric image data according to certain embodiments include: receiving unclassified cytometric image data, wherein the cytometric image data comprises a plurality of images corresponding to image channels, and iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data. Also provided are methods of training a model to classify cytometric image data, the method comprising: receiving flow cytometric data comprising unclassified cytometric image data, wherein each instance of cytometric image data comprises a plurality of images corresponding to image channels, classifying each instance of the cytometric image data of the flow cytometric data to establish ground truth data, and training a model to classify cytometric image data as comprising a particle belonging to a first category of particles by modulating aspects of at least one image of the plurality of images of each instance of the cytometric image data of the ground truth data.

### Image Data:

Image data is data obtained from a particle, e.g., a cell, using any convenient imaging technique. The term “image” is used in its conventional sense to refer to a representation of an object, e.g., a particle, such as a cell, produced by means of radiation, e.g., via illumination with light or irradiation with electromagnetic radiation or electromagnetic stimulation of molecules associated with the particle in order to emit light. In embodiments, image data means one or more images corresponding to the same field of view, and therefore the same particle, such as a cell, to the extent such is present in the field of view of the imaging technique, e.g., the field of view of an imaging flow cytometer.

Each of the one or more images of the image data may correspond to different image channels. By image channels, it is meant a range of frequencies detectible by the imaging technique, e.g., imaging flow cytometry, as such are described in greater detail below in connection with light detectors of exemplary flow cytometric technologies.

Image data is data that collectively makes up the representation of the object and may be data obtained using any convenient protocol. In some embodiments, image data obtained in methods of the invention is cytometric imaging data obtained via imaging flow cytometry techniques. Imaging flow cytometry techniques may comprise capturing one or more images of particles, e.g., cells, of a sample by causing the sample to flow in a flow path and imaging the particles passing through the flow path. Further details regarding imaging techniques, including imaging flow cytometers, are provide below.

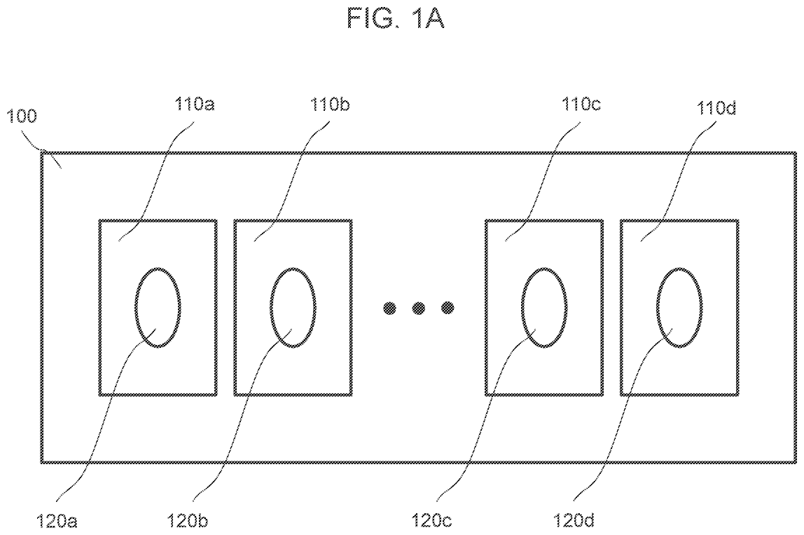

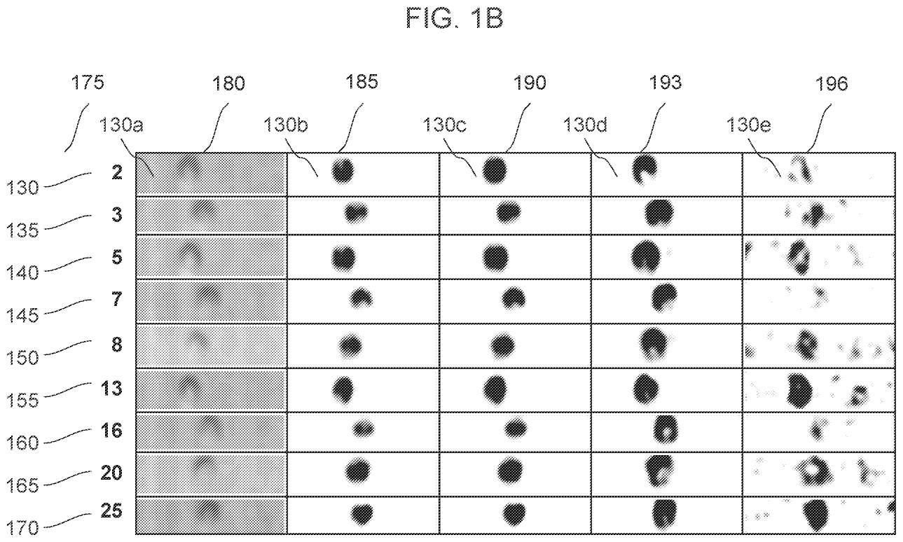

Exemplary cytometric image data according to an embodiment of the invention is illustrated schematically in FIG. 1A. Cytometric image data 100 is a collection of individual images, 110a, 110b, 110c, 110d. While four individual images are depicted 110a, 110b, 110c, 110d in connection with cytometric image data 100, in embodiments, cytometric image data may comprise any convenient number of images. In some cases, different images of the image data correspond to different channels available in the imaging technique, e.g., imaging flow cytometer. For example, cytometric image data may comprise one or two or three or four or five or six or seven or eight or nine or ten or 16 or 32 or 64 or 128 or more images. In such cases, each image may correspond, respectively to the one or two or three or four or five or six or seven or eight or nine or ten or 16 or 32 or 64 or 128 or more channels available in the imaging technique, e.g., imaging flow cytometer. The number of channels, and therefore the number of available images, may correspond to the capability or configuration of the underlying technique used to generate the image data, e.g., an imaging flow cytometer. In some cases, the imaging flow cytometer may be configured to capture image data comprising one or more brightfield images (corresponding to substantially forward scattered light (FSC)), one or more darkfield images (corresponding to substantially side scattered light (SSC)), as well as one or more channels corresponding to fluorescent light generated by, for example, one or more fluorescent labels stably associated with particles of a sample. In some cases, the imaging flow cytometer may be configurable so that the range of light frequencies associated with each channel is adjustable. In embodiments, light frequencies detected within each channel, and therefore associated with an image of the image data, may comprise any convenient range of light frequencies. Embodiments of the present invention may receive images of any number of image channels with any range or bandwidth of light frequencies detected, respectively, within each channel.

FIG. 1A also shows schematic representations 120a, 120b, 120c and 120d of a cell. That is, each of images 110a, 110b, 110c, 110d comprises a different representation 120a, 120b, 120c and 120d of the same cell, where each representation varies based on the detected light frequencies associated with each channel. While a cell is depicted in representations 120a, 120b, 120c and 120d within image data 100, in general any type of particle of interest may be imaged and subsequently classified according to embodiments of the present invention and such may vary. While each representation 120a, 120b, 120c and 120d appears substantially similar in schematic form in FIG. 1A, this need not be the case. In practice, representations of particles, such as cells, across different channels may vary (e.g., in size, shape, texture, color, light or dark spots or the like) depending on the underlying morphology of the particle, such as a cell, as well as well as the light frequencies emitted across the particle within the field of view of the image data (e.g., where one region of an imaged cell emits or reflects or scatters certain wavelengths of light but not other wavelengths of light).

FIG. 1A also illustrates how each image 110a, 110b, 110c and 110d comprises the same field of view. That is, each representation of cell 120a, 120b, 120c and 120d is present in substantially the same location within each image 110a, 110b, 110c and 110d. In other words, the difference between images 110a, 110b, 110c and 110d relates to the light frequencies detected in each image (e.g., different channels of the imaging device used to generate the different images) and, in general, does not reflect, e.g., different particles or a different field of view for each particle. In embodiments of the invention, the dimensions and/or orientation of images of the image data may be adjusted, e.g., cropped or resized or recentered or rotated, so that a particle represented by the image data is substantially centered or otherwise located at a substantially uniform location and orientation across image data. That is, in certain cases, image data may be adjusted in order that any particle represented in the image data appear in substantially the same location and orientation across a plurality of image data associated with a plurality of particles imaged in a sample. Such adjustments to image data may, in some cases, facilitate, more accurate classification of particles, e.g., cells, represented in image data via, for example, more accurate or more effective training of a model, such as a machine learning model, to classify particles based on characteristics of the image data (as opposed to artifacts of the image introduced through inconsistent orientations of the imaged particle).

FIG. 1B depicts nine rows of exemplary imaging data of nine different cells (i.e., one cell per row) for classification using embodiments of the present invention.

Each imaging data corresponds to an event number 175 (i.e., event numbers 2, 3, 5, 7, 8, 13, 16, 20 and 25), which provides a reference number for the imaging data, corresponding to events or particles, e.g., cells, imaged in a sample. The nine examples of imaging data 130, 135, 140, 145, 150, 155, 160, 165 and 170 are stacked vertically in rows in FIG. 1B. Each exemplary imaging data comprises, as mentioned above, an event number in column 175, as well as five different individual images, seen in horizontal columns 180, 185, 190, 193 and 196. A FACSVulcan™ fluorescence imaging-activated cell sorter (Becton, Dickinson and Company) was used to capture images in FIG. 1B using FACSChorus 1.3.82.1 software.

FIG. 1B illustrates how each instance of exemplary image data 130, 135, 140, 145, 150, 155, 160, 165 and 170 comprises a collection of five images (e.g., image data 130 comprises images 130a, 130b, 130c, 130d and 130e), where each image depicts the same cell across different image channels, i.e., different ranges of light wavelengths emitted or scattered or reflected from the same cell.

### Obtaining Imaging and Flow Cytometry Data:

As described above, embodiments of the present invention may be applied to image data collected using any convenient imaging technique, e.g., an imaging flow cytometer. In some embodiments, imaging data of particles, e.g., cells, may be collected in conjunction with collecting light scatter data regarding such particles by flow cytometrically analyzing such particles (i.e., traditional flow cytometry). Such imaging as well as light scattering-based techniques are described further below.

### Flow Cytometry:

A flow cytometer typically includes a sample reservoir for receiving a fluid sample, such as a sample including particles, e.g., cells, for classification or analysis, and a sheath reservoir containing a sheath fluid. The flow cytometer transports the particles (including cells, e.g., from the sample) in the fluid sample as a cell stream to a flow cell, while also directing the sheath fluid to the flow cell. To characterize the components of the flow stream, the flow stream is irradiated with light. Variations in the materials in the flow stream, such as morphologies or the presence of fluorescent labels, may cause variations in the observed light and these variations allow for characterization and, in some cases, separation. For example, particles, such as molecules, analyte-bound beads, or individual cells, in a fluid suspension are passed by a detection region in which the particles are exposed to an excitation light, typically from one or more lasers, and the light scattering and fluorescence properties of the particles are measured. Particles or components thereof typically are labeled with fluorescent dyes to facilitate detection. A multiplicity of different particles or components may be simultaneously detected by using spectrally distinct fluorescent dyes to label the different particles or components. In some implementations, a multiplicity of detectors, one for each of the scatter parameters to be measured, and one or more for each of the distinct dyes to be detected are included in the analyzer. For example, some embodiments include spectral configurations where more than one sensor or detector is used per dye. The data obtained include the signals measured for each of the light scatter detectors and the fluorescence emissions. In certain embodiments, the flow cytometric assay may detect a signal indicating the presence of the labeled secondary antibody in the sample.

### Light Source:

As summarized above, a sample (e.g., in a flow stream of the flow cytometer) may be irradiated with light from a light source. In some embodiments, the light source is a broadband light source, emitting light having a broad range of wavelengths, such as for example, spanning 50 nm or more, such as 100 nm or more, such as 150 nm or more, such as 200 nm or more, such as 250 nm or more, such as 300 nm or more, such as 350 nm or more, such as 400 nm or more and including spanning 500 nm or more. For example, one suitable broadband light source emits light having wavelengths from 200 nm to 1500 nm. Another example of a suitable broadband light source includes a light source that emits light having wavelengths from 400 nm to 1000 nm. Where methods include irradiating with a broadband light source, broadband light source protocols of interest may include, but are not limited to, a halogen lamp, deuterium arc lamp, xenon arc lamp, stabilized fiber-coupled broadband light source, a broadband LED with continuous spectrum, super luminescent emitting diode, semiconductor light emitting diode, wide spectrum LED white light source, an multi-LED integrated white light source, among other broadband light sources or any combination thereof.

In other embodiments, methods includes irradiating with a narrow band light source emitting a particular wavelength or a narrow range of wavelengths, such as for example with a light source which emits light in a narrow range of wavelengths like a range of 50 nm or less, such as 40 nm or less, such as 30 nm or less, such as 25 nm or less, such as 20 nm or less, such as 15 nm or less, such as 10 nm or less, such as 5 nm or less, such as 2 nm or less and including light sources which emit a specific wavelength of light (i.e., monochromatic light). Where methods include irradiating with a narrow band light source, narrow band light source protocols of interest may include, but are not limited to, a narrow wavelength LED, laser diode or a broadband light source coupled to one or more optical bandpass filters, diffraction gratings, monochromators or any combination thereof.

In certain embodiments, methods include irradiating the sample with one or more lasers. As discussed above, the type and number of lasers will vary depending on the sample as well as desired light collected and may be a gas laser, such as a helium-neon laser, argon laser, krypton laser, xenon laser, nitrogen laser, CO₂ laser, CO laser, argon-fluorine (ArF) excimer laser, krypton-fluorine (KrF) excimer laser, xenon chlorine (XeCI) excimer laser or xenon-fluorine (XeF) excimer laser or a combination thereof. In other instances, the methods include irradiating the flow stream with a dye laser, such as a stilbene, coumarin or rhodamine laser. In yet other instances, methods include irradiating the flow stream with a metal-vapor laser, such as a helium-cadmium (HeCd) laser, helium-mercury (HeHg) laser, helium-selenium (HeSe) laser, helium-silver (HeAg) laser, strontium laser, neon-copper (NeCu) laser, copper laser or gold laser and combinations thereof. In still other instances, methods include irradiating the flow stream with a solid-state laser, such as a ruby laser, an Nd:YAG laser, NdCrYAG laser, Er:YAG laser, Nd:YLF laser, Nd:YVO₄ laser, Nd:YCa₄O(BO₃)₃ laser, Nd:YCOB laser, titanium sapphire laser, thulim YAG laser, ytterbium YAG laser, ytterbium₂O₃ laser or cerium doped lasers and combinations thereof.

The sample may be irradiated with one or more of the above-mentioned light sources, such as two or more light sources, such as three or more light sources, such as four or more light sources, such as five or more light sources and including ten or more light sources. The light source may include any combination of types of light sources. For example, in some embodiments, the methods include irradiating the sample in the flow stream with an array of lasers, such as an array having one or more gas lasers, one or more dye lasers and one or more solid-state lasers.

The sample may be irradiated with wavelengths ranging from 200 nm to 1500 nm, such as from 250 nm to 1250 nm, such as from 300 nm to 1000 nm, such as from 350 nm to 900 nm and including from 400 nm to 800 nm. For example, where the light source is a broadband light source, the sample may be irradiated with wavelengths from 200 nm to 900 nm. In other instances, where the light source includes a plurality of narrow band light sources, the sample may be irradiated with specific wavelengths in the range from 200 nm to 900 nm. For example, the light source may be a plurality of narrow band LEDs (1 nm-25 nm) each independently emitting light having a range of wavelengths between 200 nm to 900 nm. In other embodiments, the narrow band light source includes one or more lasers (such as a laser array) and the sample is irradiated with specific wavelengths ranging from 200 nm to 700 nm, such as with a laser array having gas lasers, excimer lasers, dye lasers, metal vapor lasers and solid-state laser as described above.

Where more than one light source is employed, the sample may be irradiated with the light sources simultaneously or sequentially, or a combination thereof. For example, the sample may be simultaneously irradiated with each of the light sources. In other embodiments, the flow stream is sequentially irradiated with each of the light sources. Where more than one light source is employed to irradiate the sample sequentially, the time each light source irradiates the sample may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the sample with the light source (e.g., laser) for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to 10 microseconds. In embodiments where the sample is sequentially irradiated with two or more light sources, the duration the sample is irradiated by each light source may be the same or different.

The time period between irradiation by each light source may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each light source may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each light source is 10 microseconds. In embodiments where sample is sequentially irradiated by more than two (i.e., three or more) light sources, the delay between irradiation by each light source may be the same or different.

The sample may be irradiated continuously or in discrete intervals. In some instances, methods include irradiating the sample with the light source continuously. In other instances, the sample is irradiated with the light source in discrete intervals, such as irradiating every 0.001 millisecond, every 0.01 millisecond, every 0.1 millisecond, every 1 millisecond, every 10 milliseconds, every 100 milliseconds and including every 1000 milliseconds, or some other interval.

Depending on the light source, the sample may be irradiated from a distance which varies such as 0.01 mm or more, such as 0.05 mm or more, such as 0.1 mm or more, such as 0.5 mm or more, such as 1 mm or more, such as 2.5 mm or more, such as 5 mm or more, such as 10 mm or more, such as 15 mm or more, such as 25 mm or more and including 50 mm or more. Also, the angle or irradiation may also vary, ranging from 10° to 90°, such as from 15° to 85°, such as from 20° to 80°, such as from 25° to 75° and including from 30° to 60°, for example at a 90° angle.

In certain embodiments, methods include irradiating the sample with two or more beams of frequency shifted light. A light beam generator component may be employed having a laser and an acousto-optic device for frequency shifting the laser light. In these embodiments, methods include irradiating the acousto-optic device with the laser.

Depending on the desired wavelengths of light produced in the output laser beam (e.g., for use in irradiating a sample in a flow stream), the laser may have a specific wavelength that varies from 200 nm to 1,500 nm, such as from 250 nm to 1,250 nm, such as from 300 nm to 1,000 nm, such as from 350 nm to 900 nm and including from 400 nm to 800 nm. The acousto-optic device may be irradiated with one or more lasers, such as two or more lasers, such as three or more lasers, such as four or more lasers, such as five or more lasers and including ten or more lasers. The lasers may include any combination of types of lasers. For example, in some embodiments, the methods include irradiating the acousto-optic device with an array of lasers, such as an array having one or more gas lasers, one or more dye lasers and one or more solid-state lasers.

Where more than one laser is employed, the acousto-optic device may be irradiated with the lasers simultaneously or sequentially, or a combination thereof. For example, the acousto-optic device may be simultaneously irradiated with each of the lasers. In other embodiments, the acousto-optic device is sequentially irradiated with each of the lasers. Where more than one laser is employed to irradiate the acousto-optic device sequentially, the time each laser irradiates the acousto-optic device may independently be 0.001 microseconds or more, such as 0.01 microseconds or more, such as 0.1 microseconds or more, such as 1 microsecond or more, such as 5 microseconds or more, such as 10 microseconds or more, such as 30 microseconds or more and including 60 microseconds or more. For example, methods may include irradiating the acousto-optic device with the laser for a duration which ranges from 0.001 microseconds to 100 microseconds, such as from 0.01 microseconds to 75 microseconds, such as from 0.1 microseconds to 50 microseconds, such as from 1 microsecond to 25 microseconds and including from 5 microseconds to microseconds. In embodiments where the acousto-optic device is sequentially irradiated with two or more lasers, the duration the acousto-optic device is irradiated by each laser may be the same or different.

The time period between irradiation by each laser may also vary, as desired, being separated independently by a delay of 0.001 microseconds or more, such as 0.01 microseconds or more, such as 0.1 microseconds or more, such as 1 microsecond or more, such as 5 microseconds or more, such as by 10 microseconds or more, such as by 15 microseconds or more, such as by 30 microseconds or more and including by 60 microseconds or more. For example, the time period between irradiation by each light source may range from 0.001 microseconds to 60 microseconds, such as from 0.01 microseconds to 50 microseconds, such as from 0.1 microseconds to 35 microseconds, such as from 1 microsecond to 25 microseconds and including from 5 microseconds to 10 microseconds. In certain embodiments, the time period between irradiation by each laser is 10 microseconds. In embodiments where the acousto-optic device is sequentially irradiated by more than two (i.e., three or more) lasers, the delay between irradiation by each laser may be the same or different.

The acousto-optic device may be irradiated continuously or in discrete intervals.

In some instances, methods include irradiating the acousto-optic device with the laser continuously. In other instances, the acousto-optic device is irradiated with the laser in discrete intervals, such as irradiating every 0.001 millisecond, every 0.01 millisecond, every 0.1 millisecond, every 1 millisecond, every 10 milliseconds, every 100 milliseconds and including every 1,000 milliseconds, or some other interval.

Depending on the laser, the acousto-optic device may be irradiated from a distance which varies such as 0.01 mm or more, such as 0.05 mm or more, such as 0.1 mm or more, such as 0.5 mm or more, such as 1 mm or more, such as 2.5 mm or more, such as 5 mm or more, such as 10 mm or more, such as 15 mm or more, such as 25 mm or more and including 50 mm or more. Also, the angle or irradiation may also vary, ranging from 10° to 90°, such as from 15° to 85°, such as from 20° to 80°, such as from 25° to 75° and including from 30° to 60°, for example at a 90° angle.

In embodiments, methods include applying radiofrequency drive signals to the acousto-optic device to generate angularly deflected laser beams. Two or more radiofrequency drive signals may be applied to the acousto-optic device to generate an output laser beam with the desired number of angularly deflected laser beams, such as three or more radiofrequency drive signals, such as four or more radiofrequency drive signals, such as five or more radiofrequency drive signals, such as six or more radiofrequency drive signals, such as seven or more radiofrequency drive signals, such as eight or more radiofrequency drive signals, such as nine or more radiofrequency drive signals, such as ten or more radiofrequency drive signals, such as 15 or more radiofrequency drive signals, such as 25 or more radiofrequency drive signals, such as 50 or more radiofrequency drive signals and including 100 or more radiofrequency drive signals.

The angularly deflected laser beams produced by the radiofrequency drive signals each have an intensity based on the amplitude of the applied radiofrequency drive signal. In some embodiments, methods include applying radiofrequency drive signals having amplitudes sufficient to produce angularly deflected laser beams with a desired intensity. In some instances, each applied radiofrequency drive signal independently has an amplitude from about 0.001 V to about 500 V, such as from about 0.005 V to about 400 V, such as from about 0.01 V to about 300 V, such as from about 0.05 V to about 200 V, such as from about 0.1 V to about 100 V, such as from about 0.5 V to about 75 V, such as from about 1 V to 50 V, such as from about 2 V to 40 V, such as from 3 V to about 30 V and including from about 5 V to about 25 V. Each applied radiofrequency drive signal has, in some embodiments, a frequency of from about 0.001 MHz to about 500 MHz, such as from about 0.005 MHz to about 400 MHz, such as from about 0.01 MHz to about 300 MHz, such as from about 0.05 MHz to about 200 MHz, such as from about 0.1 MHz to about 100 MHz, such as from about 0.5 MHz to about 90 MHz, such as from about 1 MHz to about 75 MHz, such as from about 2 MHz to about 70 MHz, such as from about 3 MHz to about 65 MHz, such as from about 4 MHz to about 60 MHz and including from about 5 MHz to about 50 MHz.

In these embodiments, the angularly deflected laser beams in the output laser beam are spatially separated. Depending on the applied radiofrequency drive signals and desired irradiation profile of the output laser beam, the angularly deflected laser beams may be separated by 0.001 μm or more, such as by 0.005 μm or more, such as by 0.01 μm or more, such as by 0.05 μm or more, such as by 0.1 μm or more, such as by 0.5 μm or more, such as by 1 μm or more, such as by 5 μm or more, such as by 10 μm or more, such as by 100 μm or more, such as by 500 μm or more, such as by 1,000 μm or more and including by 5,000 μm or more. In some embodiments, the angularly deflected laser beams overlap, such as with an adjacent angularly deflected laser beam along a horizontal axis of the output laser beam. The overlap between adjacent angularly deflected laser beams (such as overlap of beam spots) may be an overlap of 0.001 μm or more, such as an overlap of 0.005 μm or more, such as an overlap of 0.01 μm or more, such as an overlap of 0.05 μm or more, such as an overlap of 0.1 μm or more, such as an overlap of 0.5 μm or more, such as an overlap of 1 μm or more, such as an overlap of 5 μm or more, such as an overlap of 10 μm or more and including an overlap of 100 μm or more.

### Light Detectors:

Aspects of the present methods include collecting scattered or fluorescent light with a light detector, such as a fluorescent light detector. A fluorescent light detector may, in some instances, be configured to detect fluorescence emissions from fluorescent molecules, e.g., labeled specific binding members (such as labeled antibodies that specifically bind to markers of interest) associated with the particle in the flow cell. In certain embodiments, methods include detecting fluorescence from the sample with one or more fluorescent light detectors, such as two or more, such as three or more, such as four or more, such as five or more, such as six or more, such as seven or more, such as eight or more, such as nine or more, such as ten or more, such as 15 or more and including 25 or more fluorescent light detectors. In embodiments, each of the fluorescent light detectors is configured to generate a fluorescence data signal. Fluorescence from the sample may be detected by each fluorescent light detector, independently, over one or more of the wavelength ranges of 200 nm to 1,200 nm. In some instances, methods include detecting fluorescence from the sample over a range of wavelengths, such as from 200 nm to 1,200 nm, such as from 300 nm to 1,100 nm, such as from 400 nm to 1,000 nm, such as from 500 nm to 900 nm and including from 600 nm to 800 nm. In other instances, methods include detecting fluorescence with each fluorescence detector at one or more specific wavelengths. For example, the fluorescence may be detected at one or more of 450 nm, 518 nm, 519 nm, 561 nm, 578 nm, 605 nm, 607 nm, 625 nm, 650 nm, 660 nm, 667 nm, 670 nm, 668 nm, 695 nm, 710 nm, 723 nm, 780 nm, 785 nm, 647 nm, 617 nm and any combinations thereof, depending on the number of different fluorescent light detectors in the subject light detection system. In certain embodiments, methods include detecting wavelengths of light which correspond to the fluorescence peak wavelength of certain fluorophores present in the sample. In embodiments, fluorescent flow cytometer data is received from one or more fluorescent light detectors (e.g., one or more detection channels), such as two or more, such as three or more, such as four or more, such as five or more, such as six or more and including eight or more fluorescent light detectors (e.g., eight or more detection channels).

Light from the sample may be measured at one or more wavelengths of, such as at five or more different wavelengths, such as at ten or more different wavelengths, such as at 25 or more different wavelengths, such as at 50 or more different wavelengths, such as at 100 or more different wavelengths, such as at 200 or more different wavelengths, such as at 300 or more different wavelengths and including measuring the collected light at 400 or more different wavelengths.

The collected light may be measured continuously or in discrete intervals. In some instances, methods include taking measurements of the light continuously. In other instances, the light is measured in discrete intervals, such as measuring light every 0.001 millisecond, every 0.01 millisecond, every 0.1 millisecond, every 1 millisecond, every 10 milliseconds, every 100 milliseconds and including every 1,000 milliseconds, or some other interval.

Measurements of the collected light may be taken one or more times during the subject methods, such as 2 or more times, such as 3 or more times, such as 5 or more times and including 10 or more times. In certain embodiments, the light propagation is measured 2 or more times, with the data in certain instances being averaged.

In certain embodiments, methods include spectrally resolving the light from each fluorophore of a fluorophore-biomolecule pair in the sample. In some embodiments, the overlap between each different fluorophore is determined and the contribution of each fluorophore to the overlapping fluorescence is calculated. In some embodiments, spectrally resolving light from each fluorophore includes calculating a spectral unmixing matrix for the fluorescence spectra for each of the plurality of fluorophores having overlapping fluorescence in the sample detected by the light detection system. In certain instances, spectrally resolving the light from each fluorophore and calculating a spectral unmixing matrix for each fluorophore may be used to estimate the abundance of each fluorophore, such as for example to resolve the abundance of target cells in the sample.

In certain embodiments, methods include spectrally resolving light detected by a plurality of photodetectors such as described e.g., U.S. Pat. No. 11,009,400; U.S. Patent Application Publication Nos. 20210247293 and 20210325292; the disclosures of which are herein incorporated by reference in their entirety. For example, spectrally resolving light detected by the plurality of photodetectors of the second set of photodetectors may be include solving a spectral unmixing matrix using one or more of: 1) a weighted least square algorithm; 2) a Sherman-Morrison iterative inverse updater; 3) an LU matrix decomposition, such as where a matrix is decomposed into a product of a lower-triangular (L) matrix and an upper-triangular (U) matrix; 4) a modified Cholesky decomposition; 5) by QR factorization; and 6) calculating a weighted least squares algorithm by singular value decomposition. In certain embodiments, methods further include characterizing the spillover spreading of the light detected by a plurality of photodetectors such as described e.g., in U.S. Patent Application Publication No. 20210349004, the disclosure of which is herein incorporated by reference.

In certain instances, the abundance of fluorophores associated with (e.g., chemically associated (i.e., covalently, ionically) or physically associated) a target particle is calculated from the spectrally resolved light from each fluorophore associated with the particle. For instance, in one example the relative abundance of each fluorophore associated with a target particle is calculated from the spectrally resolved light from each fluorophore. In another example, the absolute abundance of each fluorophore associated with the target particle is calculated from the spectrally resolved light from each fluorophore. In certain embodiments, a particle may be identified or classified based on the relative abundance of each fluorophore determined to be associated with the particle. In these embodiments, the particle may be identified or classified by any convenient protocol such as by: comparing the relative or absolute abundance of each fluorophore associated with a particle with a control sample having particles of known identity; or by conducting spectroscopic or other assay analysis of a population of particles (e.g., cells) having the calculated relative or absolute abundance of associated fluorophores.

In certain embodiments, methods may include sorting one or more of the particles (e.g., cells) of the sample that are identified based on the estimated abundance of the fluorophores associated with the particle. The term “sorting” is used herein in its conventional sense to refer to separating components (e.g., droplets containing cells, droplets containing non-cellular particles such as biological macromolecules) of a sample and in some instances, delivering the separated components to one or more sample collection containers. For example, methods may include sorting 2 or more components of the sample, such as 3 or more components, such as 4 or more components, such as 5 or more components, such as 10 or more components, such as 15 or more components and including sorting 25 or more components of the sample. In sorting particles identified based on the abundance of fluorophores associated with the particle, methods include data acquisition, analysis and recording, such as with a computer, where multiple data channels record data from each detector used in obtaining the overlapping spectra of the plurality of fluorophore-biomolecule reagent pairs associated with the particle. In these embodiments, analysis includes spectrally resolving light (e.g., by calculating the spectral unmixing matrix) from the plurality of fluorophores of the fluorophore-biomolecule reagent pairs having overlapping spectra that are associated with the particle and identifying the particle based on the estimated abundance of each fluorophore associated with the particle. This analysis may be conveyed to a sorting system which is configured to generate a set of digitized parameters based on the particle classification. In some embodiments, methods for sorting components of a sample include sorting particles (e.g., cells in a biological sample), such as described in U.S. Pat. Nos. 3,960,449; 4,347,935; 4,667,830; 5,245,318; 5,464,581; 5,483,469; 5,602,039; 5,643,796; 5,700,692; 6,372,506 and 6,809,804, the disclosures of which are herein incorporated by reference. In some embodiments, methods include sorting components of the sample with a particle sorting module, such as those described in U.S. Pat. Nos. 9,551,643 and 10,324,019, U.S. Patent Publication No. 2017/0299493 and International Patent Publication No. WO/2017/040151, the disclosure of which is incorporated herein by reference. In certain embodiments, cells of the sample are sorted using a sort decision module having a plurality of sort decision units, such as those described in U.S. Pat. No. 11,085,868, the disclosure of which is incorporated herein by reference.

Flow cytometric assay procedures are well known in the art. See, e.g., Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain aspects, flow cytometrically assaying a composition involves using a flow cytometer capable of simultaneous excitation and detection of multiple fluorophores, such as a BD Biosciences FACSCanto™ flow cytometer, used substantially according to the manufacturer's instructions. Methods of the present disclosure may involve image cytometry, such as is described in Holden et al. (2005) Nature Methods 2:773 and Valet, et al. 2004 Cytometry 59:167-171, the disclosures of which are incorporated herein by reference.

Suitable flow cytometry systems may include, but are not limited to, those described in Ormerod (ed.), Flow Cytometry: A Practical Approach, Oxford Univ. Press (1997); Jaroszeski et al. (eds.), Flow Cytometry Protocols, Methods in Molecular Biology No. 91, Humana Press (1997); Practical Flow Cytometry, 3rd ed., Wiley-Liss (1995); Virgo, et al. (2012) Ann Clin Biochem. January; 49(pt 1):17-28; Linden, et. al., Semin Throm Hemost. 2004 October; 30(5):502-11; Alison, et al. J Pathol, 2010 December; 222(4):335-344; and Herbig, et al. (2007) Crit Rev Ther Drug Carrier Syst. 24(3):203-255; the disclosures of which are incorporated herein by reference. In certain instances, flow cytometry systems of interest include BD Biosciences FACSCanto™ flow cytometer, BD Biosciences FACSCanto™ II flow cytometer, BD Accuri™ flow cytometer, BD Accuri™ C6 Plus flow cytometer, BD Biosciences FACSCelesta™ flow cytometer, BD Biosciences FACSLyric™ flow cytometer, BD Biosciences FACSVerse™ flow cytometer, BD Biosciences FACSymphony™ flow cytometer, BD Biosciences LSRFortessa™ flow cytometer, BD Biosciences LSRFortessa™ X-20 flow cytometer, BD Biosciences FACSPresto™ flow cytometer, BD Biosciences FACSVia™ flow cytometer and BD Biosciences FACSCalibur™ cell sorter, a BD Biosciences FACSCount™ cell sorter, BD Biosciences FACSLyric™ cell sorter, BD Biosciences Via™ cell sorter, BD Biosciences Influx™ cell sorter, BD Biosciences Jazz™ cell sorter, BD Biosciences Aria™ cell sorter, BD Biosciences FACSAria™ II cell sorter, BD Biosciences FACSAria™ III cell sorter, BD Biosciences FACSAria™ Fusion cell sorter and BD Biosciences FACSMelody™ cell sorter, BD Biosciences FACSymphony™ S6 cell sorter or the like.

In some embodiments, subject methods comprise applying flow cytometric systems, such those described in U.S. Pat. Nos. 10,663,476; 10,620,111; 10,613,017; 10,605,713; 10,585,031; 10,578,542; 10,578,469; 10,481,074; 10,302,545; 10,145,793; 10,113,967; 10,006,852; 9,952,076; 9,933,341; 9,726,527; 9,453,789; 9,200,334; 9,097,640; 9,095,494; 9,092,034; 8,975,595; 8,753,573; 8,233,146; 8,140,300; 7,544,326; 7,201,875; 7,129,505; 6,821,740; 6,813,017; 6,809,804; 6,372,506; 5,700,692; 5,643,796; 5,627,040; 5,620,842; 5,602,039; 4,987,086; 4,498,766; the disclosures of which are herein incorporated by reference in their entirety.

In certain instances, flow cytometry systems of the invention are configured for imaging particles in a flow stream by fluorescence imaging using radiofrequency tagged emission (FIRE), such as those described in Diebold, et al. Nature Photonics Vol. 7(10); 806-810 (2013) as well as described in U.S. Pat. Nos. 9,423,353; 9,784,661; 9,983,132; 10,006,852; 10,078,045; 10,036,699; 10,222,316; 10,288,546; 10,324,019; 10,408,758; 10,451,538; 10,620,111; and U.S. Patent Publication Nos. 2017/0133857; 2017/0328826; 2017/0350803; 2018/0275042; 2019/0376895 and 2019/0376894 the disclosures of which are herein incorporated by reference. Image data may comprise flow cytometric data obtained via a FIRE protocol, e.g., with a FACSDiscover flow cytometer, such as described in Schraivogel et al., Science Vol. 375(6578); 315-320 (2022), of a labeled particle, e.g., cell, in accordance with embodiments of the invention. Image data may be obtained in part from fluorophores that have little impact on other detector, such as, for example, conjugated polymeric dyes BB515, BB550 and BB790 (BD Biosciences).

### Imaging Flow Cytometry:

In connection with obtaining cytometric imaging data for analysis, in certain instances, as described above, the flow stream is irradiated with a plurality of beams of frequency-shifted light and a particle, e.g., a cell, in the flow stream is imaged by fluorescence imaging using radiofrequency tagged emission (FIRE) to generate a frequency-encoded image, such as those described in Diebold, et al., Nature Photonics Vol. 7(10); 806-810 (2013), as well as described in U.S. Pat. Nos. 9,423,353; 9,784,661; 9,983,132; 10,006,852; 10,078,045; 10,036,699; 10,222,316; 10,288,546; 10,324,019; 10,408,758; 10,451,538; 10,620,111; and U.S. Patent Publication Nos. 2017/0133857; 2017/0328826; 2017/0350803; 2018/0275042; 2019/0376895 and 2019/0376894 the disclosures of which are herein incorporated by reference. In such instances, flow cytometric data may include image data of particles, e.g., cells present in the sample. See, e.g., Schraivogel et al., Science Vol. 375(6578); 315-320 (2022), the disclosure of which is incorporated herein in its entirety, as well as U.S. Provisional Patent Application Ser. No. 63/256,974), the disclosure of which is incorporated herein in its entirety.

### Classifying Particles:

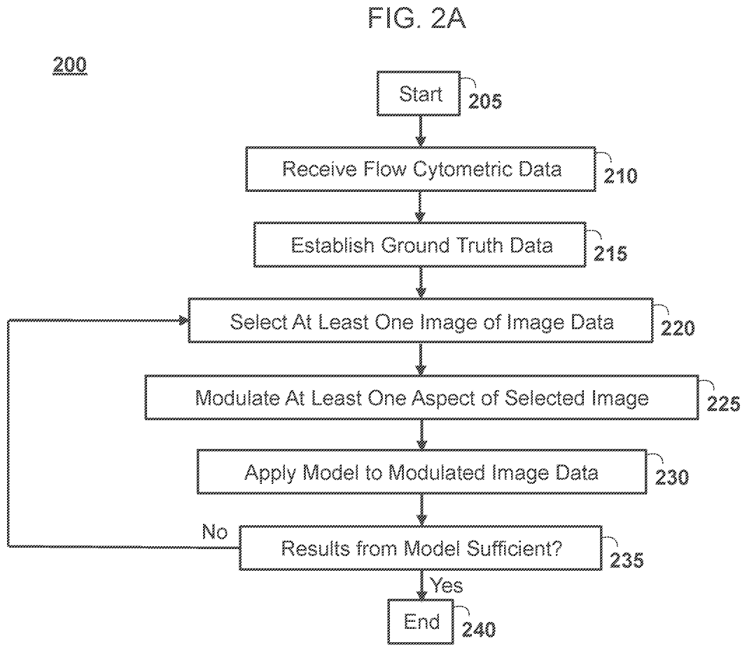

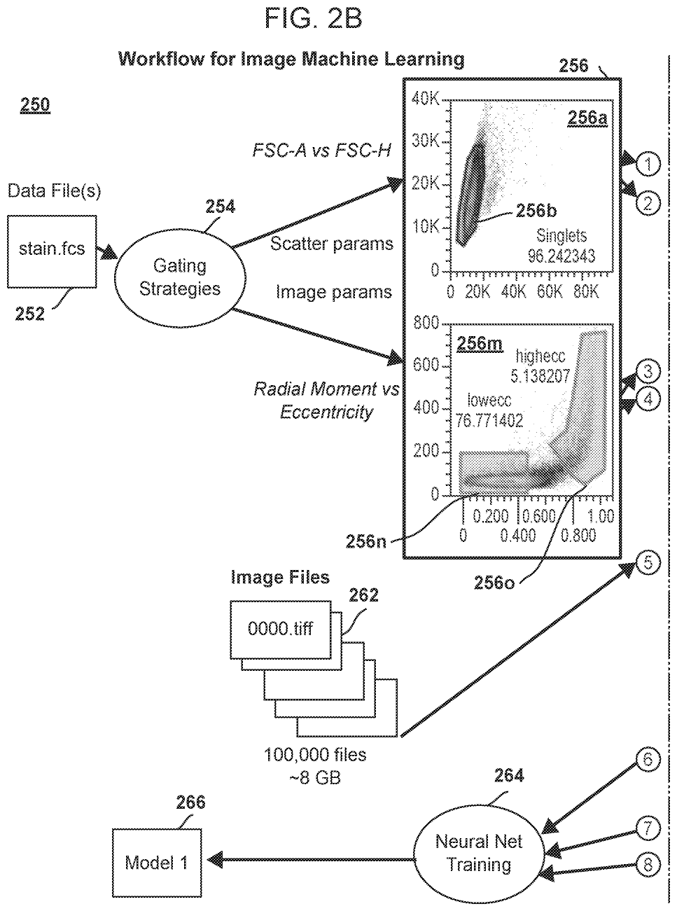

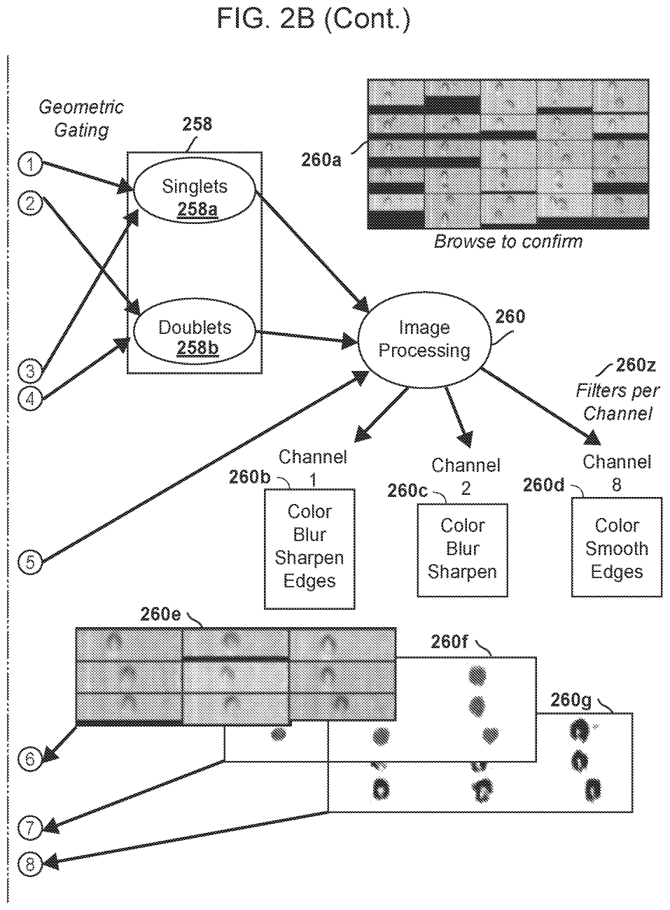

FIG. 2A illustrates a flow diagram 200 of a method for classifying cytometric image data using single cell images according to an embodiment of the present invention. Flow diagram 200 is an exemplary embodiment of the present invention provided for illustrative purposes. Flow diagram 200 is explained in terms of classifying particles that are cells into cell types. However, embodiments of the present invention are not limited to classifying particles that are cells. Any convenient particles capable of being imaged (e.g., using the techniques described above; by an imaging flow cytometer), including, but not limited to, cells, present in a sample may be classified by applying embodiments of the present invention, and such may vary. Further, as mentioned, flow diagram 200 relates to classifying cells into cell types. However, embodiments of the present invention are not limited to classifying cells into cell types.

Any convenient classification of particle image data where a model, such as models described herein (e.g., convolutional neural network), can be configured or trained to classify, including, but not limited to, cell type, may be applied in embodiments of the present invention, and such may vary. For example, images of cells may be classified based on whether the image represents an image of a singlet (single cell) or a doublet (double cell). In other cases, images of cells may be classified based on whether the image represents a cell undergoing certain intra-cellular activity. In still other cases, images of cells may be classified based on whether the image represents a cell undergoing certain inter-cellular activity.

Flow diagram 200 starts at step 205. From starting step 205, the process proceeds next to step 210.

At step 210, cytometric data is received. As described in detail above, cytometric data of interest comprises cytometric image data, such as cytometric image data comprising image data similar to exemplary image data 100 depicted in FIG. 1A or image data 130, 135, 140, 145, 150, 155, 160, 165 and 170 depicted in FIG. 1B. Cytometric image data may be data generated by, i.e., detected by, an imaging flow cytometer such as, exemplary flow cytometers capable of imaging particles described herein. The cytometric image data received at step 210 comprises cytometric image data corresponding to a plurality of cells present in a sample. In other words, the cytometric image data comprises a plurality of instances of cytometric image data, where each instance corresponds to a cell imaged in the same way, and where each instance of cytometric image data includes a plurality of images, e.g., corresponding to different channels of the imaging flow cytometer.

Cytometric data received at step 210 further comprises light scattering and/or fluorescent characteristics of detected cells in the sample, such as data generated by traditional or non-imaging flow cytometers described herein. The light scattering and/or fluorescent characteristics of detected cells received at step 210 corresponds to each imaged cell, such that for each detected cell, cytometric data available for such cell includes both light scattering and/or fluorescent characteristics as well as cytometric image data. Exemplary light scattering and/or fluorescent characteristics of detected cells in the sample include forward scattered light (FSC) data, such as pulse height (FSC-H), pulse width (FSC-W) or pulse area (FSC-A) as well as side scattered light (SSC) data, such as pulse height (SSC-H), pulse width (SSC-W) or pulse area (SSC-A). Exemplary light scattering and/or fluorescent characteristics of detected cells in the sample may further include data corresponding to fluorescent light detected from cells in the sample (i.e., light emitted by one or more molecules, e.g., fluorescent dyes, etc., stably associated with a detected cell).

Cytometric data received at step 210 comprises unclassified cytometric data. By unclassified, it is meant that the cytometric data corresponds to particles that have not yet been classified as desired (e.g., comprises imaging data of cells that have not yet been classified into cell types).

Upon completion of receiving flow cytometric data at step 210, flow diagram 200 next moves to step 215.

At step 215, ground truth data is established. In embodiments, a model is trained at step 215 to classify particles in cytometric image data using such ground truth data.

By ground truth data, it is meant using one or more of light scattering or fluorescent characteristics or cytometric image data of detected cells to establish characteristics of the detected cells. Ground truth data may be established using, for example, a subset of the cytometric data received at step 210 or may be established using another training data set comprising flow cytometric data that share the characteristics of the cytometric data received at step 210, as described above. For example, one or more of: light scattering characteristics or fluorescent characteristics or imaging characteristics may be used to perform one or more of gating or clustering or statistical analysis on the cytometric data to identify cell populations. Cytometric image data may be used to establish ground truth data by using, for example, spatial image parameters of the cytometric image data, such as, for example, radial moment or eccentricity.

In some cases, light scattering characteristics may be utilized to identify ground truth data related to identifying images representing single cells (singlets) versus images representing double cells (doublets). For example, establishing ground truth data regarding identifying single cells (singlets) versus double cells (doublets) may comprise: (i) plotting forward scattered light pulse area (FSC-A) against forward scattered light height (FSC-H), followed by (ii) applying a geometric gate to such plotted data where the gate partitions single cells (singlets) from non-singlets.

In some cases, establishing ground truth data of single cells (singlets) versus double cells (doublets) may comprise (either independently or in combination with light scattering data such as that previously described): (i) plotting a measurement of a radial moment of an image of a cell observed in the cytometric image data, against a measurement of eccentricity of the image of the cell observed in the cytometric image data, followed by (ii) applying a gating or clustering strategy to such plot to segregate singlets from doublets. Radial moment may be computed as the mean-square distance of the signal from the centroid, and eccentricity may be computed as a ratio of magnitudes of the spread along the two principal components of the image.

Results from gating light scattering data (e.g., FSC-A versus FSC-H, as described above) and gating or clustering cytometric image data (e.g., radial moment versus eccentricity, as described above) as well as results from gating or clustering or applying statistical analysis to fluorescent data, if any, may be combined to establish results, i.e., ground truth data, regarding cells detected in the sample from which the cytometric data is derived.

In embodiments, ground truth data, such as, for example, ground truth particle populations, such as ground truth cell populations (i.e., ground truth data about different cell populations in a sample) can be determined, for example, by a human by gating or by directed clustering. In other embodiments, ground truth data, such as, for example, ground truth cell populations, could also be determined without a prior knowledge of what particle, e.g., cell, subsets are present. For example, ground truth data could be determined by invoking a dimensionality reduction algorithm followed by a clustering algorithm to identify distinct subsets. Such an approach would allow the identification of different subsets of particles, e.g., cell populations, by identifying that they are different from one another but without really knowing what such particles are (i.e., knowing what the cell populations are). In still other embodiments, for machine learning applications, such as neural network computations, ground truth data is established when a sufficient number of data points (images; i.e., a subset of images of the cytometric data received at step 210) is acquired for each population to be able to differentiate the subsets (by the machine learning approach, such as a neural network) in the presence of the inherent variability of the particles (e.g., cells). In such embodiments, in some cases, at least 10 or at least 100 or at least 500 or at least 1,000 or at least 5,000 or more images per population is preferred.

In embodiments of the present invention, traditional flow cytometry data may be present and available when establishing ground truth data. However, usage of such traditional flow cytometry data is optional, since image-derived data (e.g., an eccentricity or radial moment derived from image data) is available that can alternatively be used in connection with establishing ground truth data. In some embodiments, data sets can be combined simply by classifying them with the same labels. For example, singlets versus doublets may be defined using multiple gating approaches and from multiple user's analysis and subsequently combined to provide input training data to a machine learning approach, such as a neural network or other deep learning approach.

In some cases, establishing ground truth data may further comprise an operator or analyst browsing a subset of the cytometric data and the associated ground truth for each particle, e.g., cell, detected in the cytometric data to visually confirm that the gating or clustering or statistical analysis applied to establish such ground truth resulted in expected images (i.e., an expected categorization or partitioning of images). For example, an operator or analyst may observe a subset of cytometric image data and the associated results of establishing ground truth data to confirm that cells were accurately identified and labeled. That is, in the example discussed above of identifying single cells (singlets) from images of double cells (doublets), an operator or analyst may review a subset of cytometric image data to confirm that single cells (singlets) were distinguished (and appropriately labeled) from images of double cells (doublets).

Any convenient technique may be used, in embodiments, to train the model using the ground truth data, as such training techniques are described in greater detail herein.

Upon completion of establishing ground truth data and, in some cases, training the model, at step 215, flow diagram 200 next moves to step 220.

At step 220, at least one image of the image data is selected. An image of the image data may be, for example, any one of images 110a, 110b, 110c or 110d of exemplary cytometric image data 100 illustrated in FIG. 1A. Selecting an image of the cytometric image data comprises identifying an image for subsequent processing, as described in detail below.

An image of the cytometric image data may be selected using any convenient technique and such may vary. In some cases, an image of the image data may be selected at random. In some cases, an image of the image data may be selected based on image characteristics, such as, for example, an estimate of the effect of an image modulation applied to an image of the image data. That is, an image may be selected based on an estimate of how the image may respond to certain image modulation techniques. For example, an image may be selected based on an estimate that the image may be substantially affected, i.e., changed, by application of a “sharpening” image filter or a “blurring” image filter. In other cases, an image of the image data may be selected based on image characteristics that estimate differences between the image and other images of the image data. That is, an image may be selected because it differs from other images of the image data (i.e., it is the most unique of the images of the image data).

As described in detail below, in some cases, flow diagram 200 may proceed to loop back to step 220 after step 235 (i.e., iterate), at which point the same or a different image of the image data may be selected. In some cases, the image selected may be based in part on whether the image was previously selected in conjunction with the results of applying the model to the image data (i.e., at step 230), as described in detail below.

The at least one images of the cytometric image data selected at step 220 may be identified as having been selected using any convenient technique, such as, for example, a label based on the one or more channels associated with the selected image or images.

Upon completion of selecting at least one image of the cytometric image data at step 220, the flow diagram 200 next moves to step 225.

At step 225, at least one aspect of the at least one images selected at step 220 is modulated. By modulating an aspect of an image, it is meant changing the image in any convenient manner and such may vary. In general, in embodiments, desirable changes to the at least one image are those changes that result in improving the effectiveness of an image classification model, as such model is described below. Modulating at least one image of the cytometric image data may improve the effectiveness of a classification model by, for example, highlighting or emphasizing or clarifying characteristics of the image data that, for example, represent important distinguishing characteristics of the imaged particle, e.g., cell. For example, applying an image modulation technique to an image may bring into focus a shape or other feature of an imaged cell, where such shape or other feature is indicative of a cell type. At the same time, or alternatively, modulating at least one image of the cytometric image data may improve the effectiveness of a classification model by, for example, diminishing a distinguishing feature of the at least one images of the cytometric image data that corresponds only to, for example, an artifact of the image or the image acquisition technique as opposed to a feature that truly represents a distinguishing characteristic of the particle, e.g., cell. For example, applying an image modulation technique to an image may reduce or remove an aspect of a shape or other feature of an imaged cell, where such aspect of a shape or other feature does not accurately reflect the imaged cell and would otherwise be indicative of a cell type. In other words, certain image modulations may have the effect of amplifying true distinguishing characteristics of the imaged particle, e.g., cell, or reducing (i.e., minimizing) false distinguishing characteristics of the imaged particle, e.g., cell. Further, modulating at least one image of the cytometric image data may improve the effectiveness of a classification model by, for example, highlighting features or characteristics present across two or more images of the cytometric image data. That is, modulating techniques may leverage image features by emphasizing additional information related to features detected between multiple imaging channels.

Image modulations that have the effect of improving the effectiveness of a model may vary widely; may depend on characteristics of the underlying model as well as the cytometric image data; and are unlikely to be completely knowable in a priori. Therefore, as described in detail below, modulating one or more aspects of at least one image of the cytometric image data comprises an iterative process, where repeated iterations allow for an empirical approach to discovering effective modulations to images (e.g., by conducting a search or sampling of the space of potential image modulations). In embodiments, image modulation techniques may accomplish image enhancement, i.e., to improve the detectability of image features, such as distinguishing characteristics of cell images that correspond to classification criteria for classifying cells by cell type. In other embodiments, image modulation techniques may accomplish image restoration, i.e., restoring a degraded image by attempting to reverse the degradation process. In still other embodiments, modulating an image may improve the effectiveness of a model by removing noise or sharpening boundaries or highlighting distinct areas of the pixels of images.

In some cases, modulating aspects of at least one image comprises applying a digital signal processing technique to the at least one image. By digital signal processing, it is meant using digital processing (i.e., via a computer or other digital system, such as a specialized digital signal processor, such a graphics processor) to perform one or more signal processing operations. In other cases, modulating aspects of at least one image comprises applying a noise reduction technique to the at least one image. In still other cases, modulating aspects of at least one image comprises applying one or more of the following techniques to the at least one image: adding color, removing color, blurring the image, sharpening the image or defining edges. In yet other cases, modulating aspects of at least one image comprises applying an image filter to the at least one image. Image filters of interest include, for example, one or more of: a linear filter, a non-linear filter, a low-pass filter, a high-pass filter, a spatial filter or a frequency filter. Image filters of interest may further include, for example, one or more of: a smoothing filter, a box filter, a Gaussian filter or a Laplace filter. Further details regarding image modulation techniques are described in Shapiro, L. G. and Stockman, G. C. (2001). Computer Vision. New Jersey: Prentice Hall, as well as Bishop, C. M. (2006). Pattern Recognition and Machine Learning. New York: Springer, the disclosures of each of which are incorporated herein in their entireties. In embodiments, image filters can also perform thresholding (e.g., ignoring pixels above or below any desired threshold value, such as threshold intensity or color or greyscale value) or inverting (e.g., turning black pixels to white pixels or vice versa, light gray pixels to dark gray pixels or vice versa).

A particular image modulation technique may comprise a type of image modulation (e.g., a technique having a blurring or a sharpening effect on the image) as well as one or more corresponding parameters, such as a degree or magnitude or extent to which the image modulation technique is applied. For example, a noise-reduction technique may be applied with a parameter specifying the number of neighbors of each pixel to observe and take into account when performing the noise-reduction technique. In embodiments, an image modulation technique, as well as any associated parameters of the image modulation technique, may be selected using any convenient technique and such may vary. By selecting an image modulation technique, it is meant selecting the modulation technique per se as well as any associated parameters required to configure the technique.

In some cases, an image modulation technique may be selected at random. In some cases, an image modulation technique may be selected based on characteristics of the image, to which the modulation technique will be applied, such as, for example, an estimate of the effect of the image modulation applied to the image. That is, an image modulation technique may be selected based on an estimate of how the image may respond to a certain image modulation technique. For example, an image modulation technique may be selected based on an estimate that the image may be substantially affected, i.e., changed, by application of a “sharpening” image filter or a “blurring” image filter. In other cases, an image modulation technique may be selected based on image characteristics present in the image and not present in other images of the image data. That is, an image modulation technique may be selected to further highlight or amplify or, in other cases, to minimize, a difference (i.e., a potential distinguishing feature) of the image as compared with other images of the image data.

As described in detail below, in some cases, flow diagram 200 may proceed to loop back to step 225 subsequent to step 235 (i.e., iterate), at which point the same or a different image modulation technique may be selected. In some cases, the image modulation technique selected may be based in part on whether the image modulation technique was previously selected in conjunction with the results of applying the model to the image data (i.e., at step 230), as described in detail below.

In some cases, a single image modulation technique is applied to the at least one images of the image data selected at step 220. In other cases, more than one image modulation technique is applied to the at least one images of the image data selected at step 220. That is, in certain instances, more than one image modulation technique may be applied to a single image of the image of the image data selected at step 220. As a result of applying image modulation at step 225, at least one image will have been modulated by at least one image modulation technique. Such image or images, along with other images of the cytometric image data, may be referred to as the modulated image data or modulated cytometric image data.

Upon completion of modulating at least one aspect of a selected image at step 225, flow diagram 200 next moves to step 230.

At step 230, a model is applied to the modulated cytometric image data (i.e., the cytometric image data that includes the at least one image modulated at step 225). By applying a model, it is meant applying a model configured to estimate or predict a, for example, cell classification, based on the modulated image data generated at step 225. That is, applying the model to the cytometric image data may comprise estimating or predicting whether a particle, e.g., a cell, belongs to a first category of particles, e.g., a first cell type. In some cases, applying the model to the cytometric image data may comprise estimating or predicting whether a particle, e.g., a cell, belongs to any of a plurality of categories of particles, e.g., a plurality of cell types. In embodiments, applying the model comprises providing an input to the model comprising the modulated image data generated at step 225 and receiving as an output an estimate of whether the modulated image data represents a particle, e.g., a cell, belonging to one or more categories of particles, e.g., cell types. In some cases, the estimate provided by applying the model comprises an indication of whether a particle represented in the modulated image data belongs to a first category of particles or an identification of a category to which a particle represented in the modulated image data belongs.

In such embodiments, the estimate provided by applying the model may further comprise an indication of the accuracy or confidence or likelihood that the estimated category applies to the particle represented in the modulated image data. That is, results of applying the model to the modulated image data may comprise a category-related result (e.g., a cell belongs to a first category of cell types) as well as a score representing how much confidence is associated with such category-related result. The later result may be referred to as, for example, an accuracy score or a confidence score. In some cases, the result of a classification by a model for any single event is returned as a probability that the event belongs to class 1, class 2, etc. and such probability may be the confidence score for such application of the model. In such cases, such confidence score may be manifest as an additional parameter for each class, and thus can be further used in the analysis, i.e. inspected, plotted, exported.

Exemplary results of applying the model to modulated cytometric image data may comprise, for example, (x) a result that the modulated cytometric image data represents a particle, e.g., a cell, belonging to a first category, e.g., a first cell type, with a 60% confidence score or (y) a result that the modulated cytometric image data represents a particle, e.g., a cell, belonging to a first category, e.g., a first cell type, with a 90% confidence score. In the case of examples (x) and (y), example (y) includes a higher confidence score and therefore represents a more reliable estimate about the modulated image data, insofar as the model indicates a greater degree of confidence or accuracy associated with the category-based estimate.

Exemplary results of applying the model to modulated cytometric image data may further comprise, for example, (m) a result that the modulated cytometric image data does not represent (i.e., does not include an image of) a particle, e.g., a cell, belonging to a first category, e.g., a first cell type, with a 70% confidence score or (n) a result that the modulated cytometric image data does not represent (i.e., does not include an image of) a particle, e.g., a cell, belonging to a first category, e.g., a first cell type, with an 80% confidence score. In the case of examples (m) and (n), example (n) includes a higher confidence score and therefore represents a more reliable estimate about the modulated image data, insofar as the model indicates a greater degree of confidence or accuracy associated with the category-based estimate.

Exemplary results of applying the model to modulated cytometric image data may further comprise, for example, (j) a result that the modulated cytometric image data represents a particle, e.g., a cell, belonging to a first category, e.g., a first cell type, with a 90% confidence score or (k) a result that the modulated cytometric image data does not represent (i.e., does not include an image of) a particle, e.g., a cell, belonging to a first category, e.g., a first cell type, with an 80% confidence score. In the case of examples (j) and (k), notwithstanding that for example (j) the model estimates the particle belongs to the first category and for example (k) the model estimates the particle does not belong to the first category, example (k) includes a higher confidence score and therefore represents a more reliable estimate about the modulated image data, insofar as the model indicates a greater degree of confidence or accuracy associated with the category-based estimate.

Exemplary results of applying the model to modulated cytometric image data may further comprise, for example, (e) a result that the modulated cytometric image data represents a particle, e.g., a cell, belonging to a first category, e.g., a first cell type, with a 60% confidence score or (f) a result that the modulated cytometric image data does not represent (i.e., does not include an image of) a particle, e.g., a cell, belonging to a first category, e.g., a first cell type, with a 60% confidence score. In the case of examples (e) and (f), notwithstanding that for example (e) the model estimates the particle belongs to the first category and for example (f) the model estimates the particle does not belong to the first category, examples (e) and (f) include equal confidence scores and therefore are equally reliable estimates, insofar as the model indicates an equal degree of confidence or accuracy associated with the category-based estimate.

In embodiments, it is possible to measure the accuracy of the model on training data, such as ground truth data described herein (e.g., using loss of other accuracy statistics). In other embodiments, it is possible to measure how well the model performs on new data (i.e., data other than training data or data other than ground truth data described herein). Measuring how well the model performs on training data is well established, since the correct or expected or desired results are known in advance and precise statistics can be calculated based on how well the model performs relative to the correct results. In embodiments, measuring how well the model works on new, yet unseen, data may, in some cases, be somewhat subjective or may not be possible. In some cases, manual verification of a subset of results of applying the model to new, yet unseen, data may be possible.

Any convenient model capable of classifying the cytometric image data, i.e., estimating the presence of a particle belonging to a first category of particles in the cytometric image data, may be applied and such may vary. Models of interest include models capable of estimating the presence of a particle belonging to a first category of particles as well as providing a confidence score associated with the estimate where a higher (lower) confidence score corresponds to a greater (lower) likelihood that the estimate of the presence of a particle belonging to the first category of particles in the cytometric image data is accurate. In embodiments, the model comprises one or more of: a statistical model or a linear model or a computational model or a machine learning model. Machine learning models of interest comprise one or more of: a tree-based model or an artificial neural network (i.e., a neural network), such as a convolutional neural network or a deep learning model.

Artificial neural networks (i.e., computing systems inspired by biological neural networks of animal brains) of interest may comprise a collection of interconnected units, i.e., nodes, called artificial neurons. Connections (i.e., edges) between nodes (such connections being analogous to synapses in a biological brain) can transmit a signal to other nodes. Each node receives signals, processes them, and, as a result, may transmit a signal to other nodes connected to it. The “signal” at a connection may be a real number, and the output of each node may be computed by some non-linear function of the sum of its inputs. Nodes and connections typically have weights that are adjusted in connection with training the neural network model, where such training comprises a learning process. Such weights increase or decrease the strength of the signal at a connection. Nodes may have a threshold such that a signal is transmitted onwards to connected nodes only if an aggregate input signal crosses such a threshold. Nodes may be aggregated into layers. Different layers may perform different transformations on their inputs. Signals travel from a first layer (the input layer), ultimately, to the last layer (the output layer), after potentially traversing multiple intermediate layers potentially multiple times.

Other models of interest include support vector machines or a random forest algorithm or other decision tree algorithms or other models trained using, for example, supervised learning techniques.

Further details regarding models of interest, including artificial neural networks (as well as training models of interest), are provided in: Mitchell, T. M. (1997). Machine Learning. San Francisco, California: McGraw-Hill, as well as Goodfellow, I., Bengio, Y and Courville, A. (2016). Deep Learning. Cambridge, Massachusetts: The MIT Press, the disclosures of each of which are incorporated herein in their entireties.

In embodiments of the present invention, the model is trained to estimate the presence of a particle belonging to a first category of particles in the cytometric image data. By training, it is meant configuring the model, as appropriate, based on the underlying model, to produce such estimate based on the cytometric image data. For example, as described above, training a model that is an artificial neural network may comprise identifying weights corresponding to connections between nodes, where such weights affect signals transmitted between nodes.

In embodiments, a model may be trained to estimate the presence of a particle belonging to a first category of particles in the cytometric image data using one or more of: an unsupervised learning technique, a semi-supervised learning technique, a supervised learning technique or a round robin training technique.

Unsupervised learning is a model training technique corresponding to training a model to, for example, identify or recognize patterns (e.g., whether cytometric image data represents a particle belonging to a first category of particles). Unsupervised learning comprises training a model where pre-assigned labels are not provided to the model with respect to data used to train the model. That is, in the case of embodiments of the invention, no labels indicating whether a particle belonging to a first category of particles is present or not in cytometric image data are provided in connection with training the model. As a result, applying unsupervised learning to train a model entails the model itself discovering patterns among the training data.

In other embodiments, training a model comprises applying a supervised learning technique to the model. Supervised learning is a model training technique corresponding to training a model to map an input to an output based on example input-output pairs (i.e., labeled training data). As a result of applying a supervised learning technique to the model, the model infers a function from labeled training data comprising a set of training examples. Such examples comprise a pair of an input object (e.g., cytometric image data) and a desired output value (e.g., whether a particle represented in the cytometric image data belongs to a first category of particles. Such desired output value may be referred to as a supervisory signal.

In other embodiments, training a model comprises applying a semi-supervised learning technique to the model. Semi-supervised learning is a machine learning technique corresponding to training a model to, for example, identify or recognize patterns. Semi-supervised learning comprises training a model using both labeled and unlabeled training data.

In some cases, training a model comprises applying a round robin training technique to the model. By round robin training technique, it is meant that input data to the model (i.e., data used to train the model) is divided into multiple partitions such that at least a first partition is used to train the model and the remaining partition(s) are used to generate predictions using the trained model. Such process may be iterated where partitions of data previously used to train the model are subsequently used to generate predictions using the trained model. Round robin training approaches may offer benefits including identifying which data sets used for training result in more accurate predictions.

In embodiments of the present invention, the model may be trained to estimate the presence of a particle belonging to a first category of particles in the cytometric image data using all or a subset of the ground truth data generated at step 215. Such data may be used in connection with applying any convenient training technique, including supervised learning, semi-supervised learning or unsupervised learning, as described above. In embodiments, the model may be trained, using any convenient training technique, such as those described herein, using the ground truth data established at step 215. That is, in some embodiments, step 215 may further comprise training the model using the ground truth data established at step 215.

In some cases, the model may be updated (i.e., further trained or refined) based on the results of applying the model to the modulated cytometric image data at step 225. In other cases, the model may be updated (i.e., further trained or refined) based on the results of iteratively applying step 225 (i.e., returning to step 225 one or more times via step 235, as described below). In still other cases, the model may not be updated when the model is applied to non-training data (e.g., data other than that used in connection with establishing ground truth data at step 215). That is, the model may be trained at step 215, as described above, and not subsequently modified when the model is applied to data other than ground truth data described herein.

As a result of applying the model to modulate cytometric data at step 230, an estimate of whether a particle, e.g., cell, belongs to a first category, as well as, in some cases, an associated confidence score corresponding to such category estimate, are obtained. Such result may be associated with the particular cytometric data modulated and applied to the model. That is, the output obtained from applying the model may be associated with information about the modulated cytometric image data, including the images comprising cytometric image data, as well as information identifying which of the at least one images were selected for image modulation at step 220 and, further, information identifying which of the at least on aspects of the selected image were modulated (i.e., identifying details regarding the image modulation technique, such as the type of image modulation technique and configuration thereof). Such information may be recorded for reference in connection with subsequently identifying at least one image for further image modulation at step 220 and modulating at least one aspect of such selected image at step 225, in each case, upon further iterating through such steps, i.e., returning to such steps via step 235, as described below.

Upon completion of applying the model to modulated image data at step 230, flow diagram 200 next moves to step 235.

At step 235, the results of applying the model at step 220 are evaluated in order to determine whether such results are sufficient or, instead, whether further iteration through selecting at least one image of the cytometric image data at step 220, modulating an aspect of the at least one image at step 225 and applying the model to the further modulated image data at step 230 are called for. By sufficient, it is meant any convenient technique of evaluating the results of applying the model at step 230. In some cases, results of applying the model at step 230 are evaluated to identify whether a confidence score associated with the results of applying the model at step 230 satisfies a specified threshold. In some cases, a threshold may reflect a predetermined confidence score (i.e., a reference confidence score) associated with results of applying a model. In some cases, the predetermined confidence score corresponds to a confidence score associated with applying the model to the cytometric image data without the image modulation accomplished at steps 220 and 225; that is, qualitatively, the reference score may relate to whether the image modulation accomplished at steps 220 and 225 improved the results of applying the model at step 230. In other cases, a threshold may reflect an adaptive confidence score (e.g., a moving average or a maximum of previously obtained confidence scores) associated with results of applying a model. In some cases, such a threshold may be a confidence score obtained from applying the model on a prior iteration, such as the immediately prior iteration, through steps 220, 225, 230 and 235. In other cases, a threshold may relate to the number of times the process has iterated through steps 220, 225, 230 and 235 (e.g., whether a minimum number of iterations have been performed). In still other cases, a threshold may relate to a difference between a confidence score and one or more previously obtained confidence scores based on applying the model at step 225 during previous iterations. In certain cases, a determination at step 235 of whether the results of applying the model at step 225 are sufficient may relate to whether the results appear to have plateaued (i.e., an indication that iterations through steps 220, 225, 230 and 235 have ceased to yield benefits in terms of improved or more accurate results of applying the model at step 235). In some cases, a determination at step 235 of whether the results of applying the model at step 225 are sufficient may be randomly determined, e.g., via a coin flip. As mentioned above, any convenient technique of determining whether the results of applying the model to the modulated image data at step 230 may be applied and, further, different techniques for making such determination may be applied at different iterations through steps 220, 225, 230 and 235. For example, the technique for determining whether the results are sufficient may change based on the number of times the process has iterated through steps 220, 225, 230 and 235 or based on the maximum accuracy of the results obtained during a previous iteration, for example. In embodiments, the technique used for making such determination may be selected to improve the accuracy of the estimate of the presence of a particle belonging to the first category of particles in the cytometric image data. That is, the technique used for making such determination may be selected to facilitate searching for a maximum effectiveness of applying the model over a search space comprising all potential image modulations of all combinations of images of the cytometric image data. Such search space being intractably large, a heuristic-based approach for determining whether a result is sufficient may be applied. For example, such determination of whether the results of applying the model at step 230 are sufficient may comprise applying a simulated annealing technique or other probabilistic technique for approximating a global optimum of results of applying the model at step 230 to any available image selection at step 220 and image modulation at step 225.

In some embodiments, it may be desired that flow diagram 200 iterate a fixed number of times (each iteration being referred to as an epoch), such that, at step 235, evaluating the results of applying the model comprises determining whether flow diagram 200 has iterated through steps 220, 225, 230 and 235 the desired number of times, i.e., a predetermined number of times, which number may be any convenient number of iterations, such as one or more iterations.

In other embodiments, evaluating the result of applying the model at step 235 may comprise determining that a certain confidence score has been achieved, such as a threshold confidence score, which may be any convenient confidence score, or a certain accuracy of the model has been obtained, such as a threshold accuracy, which may be any convenient accuracy. When such threshold confidence score or accuracy is achieved, the result of, at step 235, evaluating the results of applying the model comprises comparing a result of applying the model with a predetermined threshold confidence score or accuracy result of applying the model.

In still other embodiments, evaluating the result of applying the model at step 235 may comprise determining that the confidence score or the accuracy of the results of applying the model have decreased. That is, evaluating the result of the applying the model may comprise determining that the most recent iteration of applying the model achieved a lower confidence score, or other determination of accuracy of applying the model, than previous applications of the model or that the results of applying the model may be trending downwards. In such cases, the result of applying the model at step 235 may be to terminate further iterations of applying the model because further applications of the model do not appear to be beneficial for purposes of classifying cytometric data.

In yet other embodiments, evaluating the result of applying the model at step 235 may comprise determining whether iterations of applying the model appear to be resulting in overfitting the data. Such a scenario may occur when the model “memorizes” the training data, i.e., when the model performs too well on training data but gets worse on validation data. In some cases, the image data selected at step 220 may comprise training data, and, further, the model may be updated, at each interval of applying the model to training data or at another convenient interval, based on the results of applying the model to such training data. In such cases when the model appears to “memorize” training data, the result of applying the model at step 235 may be to terminate further iterations of applying the model because further applications of the model do not appear to be useful for purposes of classifying cytometric data.

In the event it is determined that the results of applying the model at step 230 are sufficient, flow diagram 200 proceeds next to step 240. At step 240, the process ends. A final result of the applying the model to modulated image data comprises an estimate of whether the modulated image data includes a particle, e.g., a cell, belonging to a first category of particles, e.g., cell types. That is, the final result is of applying flow diagram 200 comprises a final estimate of whether the cytometric image data represents a particle belonging to a first category of particles. In embodiments, such final result is the result of applying the model at step 230 where such results are considered the most likely accurate of the results obtained at each iteration of step 230. That is, the final result may be the result of applying the model at step 230 with a corresponding greatest confidence score of each iteration of applying the model at step 230.

In the event it is determined that the results of applying the model at step 230 are not sufficient, flow diagram 200 returns to step 220, where a subsequent iteration through steps 220, 225, 230 and 235 is performed.

As described above, upon each iteration through step 220, the same or different image or images may be selected for modulation. Any convenient technique for determining whether the same or different image or images are selected upon subsequent iterations may be applied and such may vary. In some cases, the same (different) image or images are selected based on whether the results of applying the model over previous iterations improved (decreased) the accuracy of the results of applying the model at step 230. For example, if the previous several iterations of applying the model at step 230, in which the same image was selected for modulation in each iteration, improved the accuracy of applying the model to the modulated image data at step 230, then the same image may be selected again at step 220 on the theory that continuing to modulate the selected image is a path to a local maximum of the results of applying the model at step 230 (e.g., a local maximum confidence score). In some cases, the same (different) image or images are selected based on the number of time such image has previously been selected during previous iterations of step 220, i.e., such that each image of the cytometric image data is selected at least a minimum number of times and/or no more than a maximum number of times.

As described above, upon each iteration through step 225, the same or different aspect of the selected image(s) may be modulated. Any convenient technique for determining whether the same or different image modulation technique is selected upon subsequent iterations may be applied and such may vary. In some cases, the same (different) image modulation technique is selected based on whether the results of applying the model over previous iterations improved (decreased) the accuracy of the results of applying the model at step 230. For example, if the previous several iterations of applying the model at step 230, in which the same or similar image modulation technique was applied in each iteration, improved the accuracy of applying the model to the modulated image data at step 230, then the same or similar image modulation technique may be selected again at step 220 on the theory that continuing to modulate the selected image in a similar manner is a path to a local maximum of the results of applying the model at step 230 (e.g., a local maximum confidence score). In some cases, applying the same or similar image modulation technique involves applying the same type of technique but where such technique is configured in a different way. For example, an image blurring technique may be re-applied at a subsequent iteration of step 225 where the selected image is blurred to a greater extent upon each iteration of step 225. Alternatively, an image blurring technique may be re-applied at a subsequent iteration of step 225 to the same extent but to a different image of the cytometric image data selected at step 220. In some cases, the same (different) image modulation technique is selected based on the number of times such image modulation technique has previously been selected during previous iterations of step 225, i.e., such that each available image modulation technique is selected at least a minimum number of times and/or no more than a maximum number of times.

As described above, in the event that after subsequent iterations of steps 220, 225, 230 and 235, it is determined at step 235 that the results of applying the model at step 230 are sufficient, flow diagram 200 proceeds from step 235 to step 240, where flow diagram 200 ends. Upon ending, the flow diagram has accomplished estimating whether a particle, e.g., cell, represented in the cytometric image data belongs to a first category of particles, e.g., cell types. Such final results may be an estimate obtained from any of the iterations through steps 220, 225, 230 and 235. That is, the final result obtained upon ending flow diagram 200 need not necessarily be the results corresponding to the, e.g., last in time iteration through steps 220, 225, 230 and 235 but instead corresponding to the iteration that yielded the results most likely to be accurate (e.g., the results comprising the highest confidence score) of each of the iterations. In other words, the results obtained upon ending flow diagram 200 correspond to the results of searching for the maximum accuracy of results over a search space comprising any available image modulation of any available image of the cytometric image data.

FIG. 2B illustrates flow diagram 250 of a method for training a model to classify cytometric image data, as well as classifying cytometric image data, using single cell images according to another embodiment of the present invention. Flow diagram 250 is an exemplary embodiment of the present invention provided for illustrative purposes. Flow diagram 250 relates to classifying images of cells into classifications that are singlets or doublets. However, embodiments of the present invention are not limited to classifying cells. Any convenient particles capable of being imaged (e.g., by an imaging flow cytometer), including, but not limited to, cells, present in a sample may be classified by applying embodiments of the present invention, including by the embodiment set forth in FIG. 2B, and such may vary. Further, as mentioned, flow diagram 250 relates to classifying images of cells into single versus double cells (singlets versus doublets). However, embodiments of the present invention, including the embodiment set forth in FIG. 2B, are not limited to classifying cells as such. Any convenient classification of particle image data where a model, such as models described herein (e.g., convolutional neural networks), can be configured or trained to classify (e.g., into cell types) may be applied in embodiments of the present invention, and such may vary.

Flow diagram 250 presents additional detail, in connection with an embodiment of the present invention, regarding training a model to classify cytometric image data using single cell images, in particular using modulated image data to train a model to classify cytometric image data. Certain image-processing techniques discussed below in connection with training the model (i.e., image processing as applied to ground truth data, as described herein) but is also applicable in embodiments of the present invention in connection with applying the model to classify cytometric image data using single cell images.

Flow diagram 250 starts at step 252. At step 252, flow cytometric data, including cytometric image data, is received in the form of a computer file, “stain.fcs.” That is, the results of previously collected cytometric data were recorded in the file stain.fcs, which is accessed at step 252. While any convenient format may be used to store flow cytometric data, in the embodiment shown, the Flow Cytometry Standard (FCS) file format is used. The experimental results recorded in the file stain.fcs may have been collected on one or more convenient flow cytometric systems capable of generating traditional flow cytometric data (e.g., scatter data) as well as cytometric imaging data, such as those flow cytometric and imaging flow cytometric systems described herein.

Upon completion of obtaining flow cytometric data at step 252, flow diagram 250 next moves to step 254.

At step 254, one or more gating strategies is applied to the each of the flow cytometric data comprising light scattering data (i.e., traditional flow cytometric data) as well as the cytometric imaging data (i.e., data collected by an imaging flow cytometer). Any convenient gating pattern or strategy may be applied. In the case of flow diagram 250, in which singlets versus doublets are identified, the gating strategies explored at step 254 comprise strategies intended to segregate or partition singlets from doublets. Different gating specifications may be applied to the traditional flow cytometric data versus the imaging flow cytometric data received at step 252.

Applicable gating strategies may be determined based on any convenient data analysis technique. By data analysis technique, it is meant studying, understanding and/or characterizing the cytometric data. For example, analyzing cytometric data may comprise analyzing such data using at least a first data analysis algorithm. In other cases, analyzing cytometric data comprises analyzing such data using a first data analysis algorithm as well as one or more additional data analysis algorithms. Data analysis algorithms may be any convenient or useful algorithm for use in drawing inferences from the cytometric data. For example, in some embodiments, data analysis algorithms may entail data clustering algorithms, as described below. In other embodiments, data analysis algorithms may comprise dimensionality reduction algorithms, feature extraction algorithms, pattern recognition algorithms, or the like to, for example, facilitate visualizing multi-dimensional data.

In some embodiments gating strategies may be identified data analysis techniques that further comprise clustering the cytometric data by applying a clustering algorithm to the cytometric data. By clustering, it is meant any algorithm, technique or method used to identify subpopulations of data within cytometric data, where each element of a subpopulation shares certain characteristics with each other element of the subpopulation.

Any convenient clustering algorithm may be applied to identify clusters within the cytometric data. In some cases, population clusters can be identified (as well as gates that define the limits of the populations) can be determined automatically. Examples of methods for automated gating have been described in, for example, U.S. Pat. Nos. 4,845,653; 5,627,040; 5,739,000; 5,795,727; 5,962,238; 6,014,904; and 6,944,338; and U.S. Pat. Pub. No. 2012/0245889, each incorporated herein by reference.

In some cases, assigning particles of the cytometric data to clusters comprises applying the technique referred to as k-means clustering. By “k-means clustering” it is meant a partitioning technique that aims to partition data points for each event or cell of a test sample into k clusters so that each data point belongs to the cluster with the nearest mean. The technique of k-means clustering, including various popular embodiments that utilize k-means clustering, is further described in L. M. Weber and M. D. Robinson, Comparison of Clustering Methods for High-Dimensional Single-Cell Flow and Mass Cytometry Data, Cytometry, Part A, Journal of Quantitative Cell Science, at Vol. 89, Issue 12, pp. 1084-96, the disclosure of which is incorporated herein by reference.

In other cases, assigning particles of the cytometric data to clusters comprises applying a self-organizing map. By “self-organizing map,” it is meant applying a type of artificial neural network algorithm that, as a result of the neural network training step, produces a map, in this case, where the map comprises a collection of clusters defining the data points or cells of a sample. The technique of applying a self-organizing map, including the popular embodiment of the self-organizing map, FlowSOM, is further described in L. M. Weber and M. D. Robinson, Comparison of Clustering Methods for High-Dimensional Single-Cell Flow and Mass Cytometry Data, Cytometry, Part A, Journal of Quantitative Cell Science, at Vol. 89, Issue 12, pp. 1084-96, the disclosure of which is incorporated herein by reference. Other known or yet to be discovered clustering techniques or algorithms may be applied as desired.

In still other cases, assigning cells of the cytometric data to clusters comprises applying the technique known in the art, as the X-Shift population finding algorithm. The X-Shift algorithm, as well as practical applications thereof, is further described in N. Samusik, Z. Good, M. H. Spitzer, K. L. Davis & G. P. Nolan (2016), Automated mapping of phenotype space with single-cell data. Nature methods, at Vol. 13, Issue 6, p. 493, the disclosure of which is incorporated herein by reference. Other known or yet to be discovered clustering techniques or algorithms may be applied as desired.

Upon completion of identifying relevant gating strategies at step 254, flow diagram 250 next moves to step 256.

At step 256, the results of applying the gating strategies identified at step 254 are presented and geometric gating is applied to each of the scatter and imaging data that originated form the stain.fcs file accessed at step 252. For example, the gating strategy identified at step 254 with respect to traditional flow cytometric data (scatter data) is presented in plot 256a. In plot 256a, different aspects of forward scattered light are plotted, and a gate is applied. Specifically, FSC-A (area of forward scattered pulses) is plotted against FSC-H (height of forward scattered pulses). Gate 256b is applied to plot 256a in order to identify and segregate singlets from doublets on plot 256a.

Similarly, the gating strategy identified at step 254 with respect to the cytometric imaging data is presented in plot 256m. In plot 256m, different aspects of the shape of an imaged cell are plotted and one or more gates are applied. Specifically, a measure of radial moment (defined as the mean-square distance of the signal from the centroid) is plotted against a measure of eccentricity (defined as a ratio of magnitudes of the spread along the two principal components of the image). Gates 256n and 2560 are applied to plot 256m in order to identify and segregate singlets from doublets.

Upon completion of applying the gating strategy to plots at step 256, flow diagram 250 next moves to step 258.

At step 258, the results of applying gates at step 256 are processed to identify which flow cytometric data correspond to singlets and which to doublets. That is, at step 256, ground truth data, as described above, is established, based on applying results of the gating strategy to plots 256a and 256m, regarding flow cytometric data corresponding to singlets versus doublets. Flow cytometric data corresponding to singlets are identified in data collection 258a, and flow cytometric data corresponding to doublets are identified in data collection 258b. Data collections 258a and 258b are each comprised of aspects of traditional flow cytometric data (i.e., scatter data derived from plot 256a) as well as imaging flow cytometric data (i.e., imaging data derived from plot 256b). At step 258, each data element (i.e., each instance of cytometric image data) is labeled according to whether the gating strategy applied at steps 254 and 256 resulted in the data element being gated as a singlet or a doublet. A separate label may be associated with each data element (i.e., each instance of cytometric image data). The resulting data set of labeled cytometric image data may be referred to as ground truth data, as described herein.

Upon completion of establishing ground truth data regarding flow cytometric data corresponding to singlets versus doublets, flow diagram 250 next moves to step 260.

In connection with executing step 260, image files 262 of cytometric image data are accessed and retrieved. Image files 262 comprise a plurality of files, e.g., approximately 100,000 files or approximately 8 GB worth of imaging data. Imaging data 262 is in the form of .tiff image files, where the images may correspond to cytometric image data for each flow cytometric event. That is, image files 262 may correspond to cytometric image data of each potential singlet or doublet identified in connection with establishing ground truth data at step 258 (where each instance of cytometric image data comprises a plurality of images, each corresponding to different channels).

Continuing with respect to step 260, image data 262 may, in some cases, be examined, e.g., browsed, by an operator or data analyst in order to confirm the accuracy of the gating strategy identified and applied at steps 254, 256 and 258 to establish ground truth data. An example of image data that may be examined by an operator or an analyst at step 260 is depicted in image 260a. Image 260a is comprised of a plurality of images, where each row corresponds to different flow cytometric events (i.e., a detected cell that may be either a singlet or a doublet) and each column corresponds to different channels of the cytometric image data.

Continuing, image processing at step 260 further comprises applying one or more different filters (i.e., image modulation techniques) per each channel. At step 260, eight different image channels are processed, corresponding to channels 1, 2 . . . 8 of images 262 of the cytometric image data. Each channel of channels 1, 2 . . . 8 may correspond to, for example, different collections of wavelengths of light or brightfield images or darkfield detected by an underlying flow cytometer.

At step 260, any convenient filter may be applied per channel 260z. Exemplary filters, depicted as associated with different channels, include “color” (i.e., adding, subtracting or modifying coloring of the image), “blur” (i.e., blurring aspects of the image), “sharpen” (i.e., sharpening aspects of the image) or “edges” (i.e., emphasizing or deemphasizing edges of the image). Different filters 260b, 260c and 260d are applied to different channels. Other relevant image modulation techniques may also be applied as part of applying different filters per channel 260z, such as those image modulation techniques described above. Results of applying image modulation techniques yield different modulated cytometric image data 260e, 260f, 260g. Images 260e, 260f, 260g show applying different filters to the channels 260b, 260c, 260d. Each exemplary image 260e, 260f, 260g shows nine different cells. Image 260e shows channel 1 for the nine cells, a grayscale smoothed picture. Image 260f shows channel 2 for the same nine cells, colored in green. Image 260g shows channel 3 for those nine cells, colored in blue.

With respect to the ground truth data discussed above in connection with steps 254, 256 and 258, such image data, such as images 260e, 260f, 260g, associated with ground truth data are all input equally to image processing step 260. In other words, the labelling of the data that occurred in connection with establishing ground truth data is not relevant to the image processing applied at step 260. In some embodiments, it is important for purposes of consistent model training as well as evaluation of the model that the same image filters 260z are applied to all the input ground truth data in the exact same way.

Upon completion of imaging processing at step 260, flow diagram 250 next moves to step 264.

At step 264, a model is applied to the modulated image data in order to train the model. Any convenient model, such as those described above, may be applied. At step 264, for instance, a neural network model is applied to the modulated cytometric image data 260e, 260f and 260g generated via image processing at step 260. That is, as seen in steps 260 and 264, the model may be trained using a plurality of modulated image data, such as modulated cytometric image data 260e, 260f, 260g. The input to the neural network model applied at step 264 may comprise such modulated cytometric image data. Output of applying the neural network model at step 264 may comprise an estimate of whether such modulated cytometric image data represents a singlet or doublet cell. The neural network model applied at step 264 is being trained to estimate the presence of singlets versus doublets using any convenient technique, such as those described above. That is, at step 264, the neural network model is trained, such that ultimately, a fully trained model is produced at step 266 that can be used for predictions on, for example, yet unseen data. The inputs to the neural network model at step 264 comprise the ground truth data established in connection with steps 254, 256 and 260 (i.e., the set of images labeled as singlets and the set of images labeled as doublets), as such images are modulated at step 260. The quality of the model is assessed with accuracy statistics determined during training, e.g., statistics describing whether application of the model corresponds to classifications established in connection with generating ground truth data via gating, etc. at steps 254, 256 and 258.

An output of neural network model applied at step 264 further comprises a confidence score indicating a degree of confidence in the estimated output (i.e., a degree of confidence in whether a singlet or doublet was accurately identified by the model). After estimating the presence, or lack of, a singlet or doublet cells in the modulated image data, the neural network applied at step 264 may be updated (i.e., further trained based on such results) by, for example, adjusting the weights of node connections internal to the model, in part depending on the associated confidence score of the model's estimate of the presence of a singlet versus a doublet and/or whether the model has correctly predicted whether an instance of cytometric image data corresponds to the gating results of the ground truth data. That is, the neural network training step 264 involves iterating over the input training sets (e.g., the ground truth data established in connection with steps 254, 256 and 258), adjusting the weights of the model as the model improves its ability to classify the already labeled data. More specifically, in embodiments, the model takes a subset of the input training data (e.g., the ground truth data established in connection with steps 254, 256 and 258), iterates over that subset, adjusting the weights of the model and comparing with the known classification (i.e., the classification determined via gating strategies described above). The model then repeats this training step with a different subset of training data (e.g., the ground truth data established in connection with steps 254, 256 and 258), eventually terminating with a final model. In embodiments, in connection with training the model, an iteration occurs within the neural net training step 264. In the embodiment shown in FIG. 2B, the workflow of defining the ground truth input data and applying image processing filters is substantially linear (i.e., such that modulated image data is generated in advance).

Upon completion of applying the neural network model in order to train the model at step 264, flow diagram 260 next moves to step 266.

At step 266, flow diagram 250 ends. Applying flow diagram 250, culminating with step 266, results in a model, i.e., a neural network, having been trained to distinguish between singlets and doublets using the ground truth data as training data, where the images of ground truth data are modulated. In some cases, as a result of training the model on modulated image data, such neural network may be trained to identify still other populations of cells not initially contemplated, e.g., in connection with identifying gating strategies at step 254. In embodiments, the resulting model at step 266 is considered complete, i.e., fully trained. The model generated at step 266 may be used for future classifications (i.e., predictions) on new, yet unseen data. In some cases, the model generated at step 266 can be used on new data sets, provided they can be image processed using the same filters 260z used during generation of the model resulting at step 266. In other cases, the model generated at step 266 can be used on new data sets, where cytometric image data present in such new data sets is iteratively modulated in connection with iteratively applying the model to the cytometric image data.

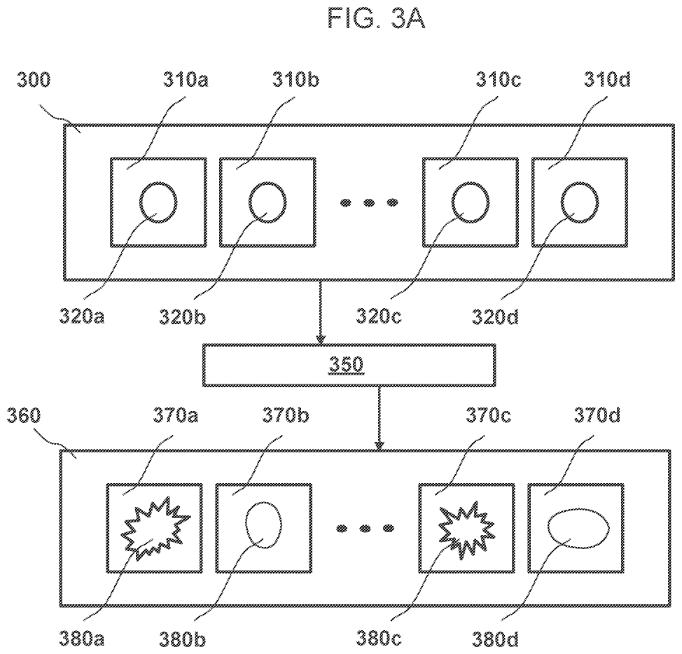

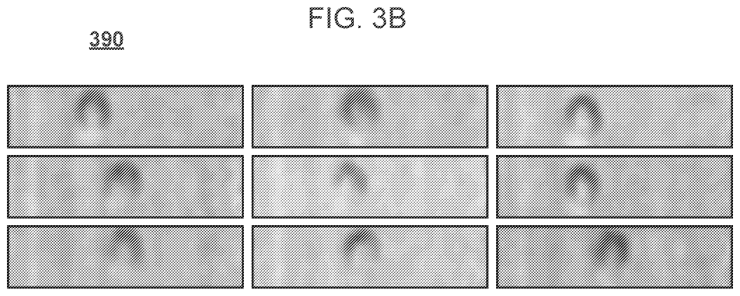

FIG. 3A presents a schematic of exemplary intermediate results of applying a method according to the present invention to cytometric image data. FIG. 3A presents exemplary cytometric image data used by and generated by an embodiment of the present invention and is provided for illustrative purposes. FIG. 3A relates to cytometric image data of cells. However, embodiments of the present invention are not limited to classifying cells. Any convenient particles capable of being imaged (e.g., by an imaging flow cytometer), including, but not limited to, cells, present in a sample may be classified by applying embodiments of the present invention.

Exemplary cytometric image data 300 includes a plurality of images, 310a, 310b, 310c, 310d, presenting images from substantially the same field of view of cell 320a, 320b, 320c, 320d, each corresponding to different image channels of an underlying flow cytometer. Cytometric image data 300 corresponds to a single flow cytometric event, e.g., the detection of a single cell for classification into a first classification of cells (e.g., singlets versus doublets, etc.).

Unmodulated cytometric image data 300 may then be applied to aspects of the present invention 350. Specifically, applying aspects of the present invention 350 corresponds to iteratively modulating aspects of at least one image of the plurality of images of the cytometric image data 300 and applying a model to the modulated cytometric image data to classify the cytometric image data. As described above, such model is trained to estimate the presence of a cell belonging to a first category of cells in the cytometric image data. As a result of applying such aspects (i.e., iteratively modulating aspects of the cytometric image data 300 and applying a model, together 350), ultimately, modulated image data 360 is generated. Modulated image data 360 corresponds to image data with modulations having been applied that result in more accurate estimates by the model of whether the cytometric image data represents an image of a cell belonging to a first category of cells.

Modulated image data 360 includes a plurality of images, 370a, 370b, 370c, 370d, presenting images from substantially the same field of view of cell 380a, 380b, 380c, 380d, each corresponding to different image channels of an underlying flow cytometer, and each having been modulated, potentially, differently or to a greater or lesser extent. As seen in the schematic representations of cell 380a, 380b, 380c, 380d, the border of cell 380a, 380b, 380c, 380d differs from the border depicted in cell 320a, 320b, 320c, 320d of unmodulated images 310a, 310b, 310c, 310d. Such differences in cell border are intended to highlight the results of image modulations applied by aspects of the model 350, where such image modulations highlight or emphasize or elucidate features of aspects of cell images used to improve estimations made by a model about whether the imaged cell belongs to a first category of cells or not. In some embodiments, it is as useful aspect of the present invention to obtain finally modulated image data 360 for use in connection with publications or otherwise obtaining an image for use illustrating aspects of the underlying cells for classification.

FIG. 3B illustrates cytometric image data 390 showing one channel of image data from nine events where the images have been modulated in connection with applying an embodiment of the present invention. Cytometric image data 390 comprises pluralities of imaging data corresponding to nine different events. With respect to image data 390, a smoothing filter was applied to each of the individual images. In embodiments of the present invention, each image of cytometric image data, such as cytometric image data 390, may be separately and independently modified using any convenient image modulation technique, as such techniques and the iterative application of such techniques are described above.

### Biological Sample:

As described above, particles, e.g., cells, imaged and/or analyzed by a flow cytometer, e.g., an imaging flow cytometer, may be present in a sample. In some examples, the sample is a biological sample. The term “biological sample” is used in its conventional sense to refer to a whole organism, plant, fungi or a subset of animal tissues, cells or component parts which may in certain instances be found in blood, mucus, lymphatic fluid, synovial fluid, cerebrospinal fluid, saliva, bronchoalveolar lavage, amniotic fluid, amniotic cord blood, urine, vaginal fluid and semen. As such, a “biological sample” refers to both the native organism or a subset of its tissues as well as to a homogenate, lysate or extract prepared from the organism or a subset of its tissues, including but not limited to, for example, plasma, serum, spinal fluid, lymph fluid, sections of the skin, respiratory, gastrointestinal, cardiovascular, and genitourinary tracts, tears, saliva, milk, blood cells, tumors, organs. Biological samples may be any type of organismic tissue, including both healthy and diseased tissue (e.g., cancerous, malignant, necrotic, etc.). In certain embodiments, the biological sample is a liquid sample, such as blood or derivative thereof, e.g., plasma, tears, urine, semen, etc., where in some instances the sample is a blood sample, including whole blood, such as blood obtained from venipuncture or fingerstick (where the blood may or may not be combined with any reagents prior to assay, such as preservatives, anticoagulants, etc.).

In some embodiments the source of the sample is a “mammal” or “mammalian”, where these terms are used broadly to describe organisms which are within the class Mammalia, including the orders carnivore (e.g., dogs and cats), Rodentia (e.g., mice, guinea pigs, and rats), and primates (e.g., humans, chimpanzees, and monkeys). In some instances, the subjects are humans. The methods may be applied to cytometric data for samples obtained from human subjects of both genders and at any stage of development (i.e., neonates, infant, juvenile, adolescent, adult), where in certain embodiments the human subject is a juvenile, adolescent or adult. While the present invention may be applied to cytometric data for samples from a human subject, it is to be understood that the methods may also be carried-out on cytometric data for samples from other animal subjects (that is, in “non-human subjects”) such as, but not limited to, birds, mice, rats, dogs, cats, livestock and horses.

Computer-Implemented Embodiments:

The various method and algorithm steps described in connection with the embodiments disclosed herein can be implemented as electronic hardware, computer software, or combinations of both. To clearly illustrate this interchangeability of hardware and software, various illustrative steps have been described above generally in terms of their functionality. Whether such functionality is implemented as hardware or software depends upon the particular application and design constraints imposed on the overall system applying a method according to the present disclosure. The described functionality can be implemented in varying ways for each particular application, but such implementation decisions should not be interpreted as causing a departure from the scope of the disclosure.

The various illustrative steps, components, and computing systems (such as devices, databases, interfaces, and engines) described in connection with the embodiments disclosed herein can be implemented or performed by a machine, such as a general purpose processor, a graphics processor unit, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor can also include primarily analog components. A computing environment can include any type of computer system, including, but not limited to, a computer system based on a microprocessor, a graphics processor unit, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module, engine, and associated databases can reside in memory resources such as in RAM memory, FRAM memory, flash memory, ROM memory, EPROM memory, EEPROM memory, registers, hard disk, a removable disk, a CD-ROM, or any other form of non-transitory computer-readable storage medium, media, or physical computer storage known in the art. An external storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

### Systems

As summarized above, aspects of the present disclosure include systems for practicing the subject methods. Systems according to certain embodiments comprise a processor comprising memory operably coupled to the processor, wherein the memory comprises instructions stored thereon, which, when executed by the processor, cause the processor to: receive unclassified cytometric image data, wherein the cytometric image data comprises a plurality of images corresponding to image channels, and iteratively modulate aspects of at least one image of the plurality of images of the cytometric image data and apply a model to the modulated cytometric image data to classify the cytometric image data, wherein the model is trained to estimate the presence of a particle belonging to a first category of particles in the cytometric image data.

Systems according to some embodiments, may include a display and operator input device. Operator input devices may, for example, be a keyboard, mouse, or the like. The processing module includes at least one general purpose processor as well as a plurality of parallel processing units, all of which have access to a memory having instructions stored thereon for performing the steps of the subject methods. The processing module may include an operating system, a graphical user interface (GUI) controller, a system memory, memory storage devices, and input-output controllers, cache memory, a data backup unit, and many other devices. The general purpose processor as well as each of the parallel processing units may be a commercially available processor, or it may be one of other processors that are or will become available. The processors execute the operating system, and the operating system interfaces with firmware and hardware in a well-known manner and facilitates the processors in coordinating and executing the functions of various computer programs that may be written in a variety of programming languages, such as Java, Perl, Python, R, Go, JavaScript, .NET, CUDA, Verilog, C++, other high level or low-level languages, as well as combinations thereof, as is known in the art. The operating system, typically in cooperation with the processor, coordinates and executes functions of the other components of the computer. The operating system also provides scheduling, input-output control, file and data management, memory management, and communication control and related services, all in accordance with known techniques. The processors may be any suitable analog or digital systems. In some embodiments, the one or more general purpose processors as well as the parallel processing units include analog electronics which provide feedback control, such as for example negative feedback control.

The system memory may be any of a variety of known or future memory storage devices. Examples include any commonly available random-access memory (RAM), magnetic medium such as a resident hard disk or tape, an optical medium such as a read and write compact disc, flash memory devices, or other memory storage device.

The memory storage device may be any of a variety of known or future devices, including a compact disc drive, a tape drive, a removable hard disk drive, or a diskette drive. Such types of memory storage devices typically read from, and/or write to, a program storage medium (not shown) such as, respectively, a compact disc, magnetic tape, removable hard disk, or floppy diskette. Any of these program storage media, or others now in use or that may later be developed, may be considered a computer program product. As will be appreciated, these program storage media typically store a computer software program and/or data. Computer software programs, also called computer control logic, typically are stored in system memory and/or the program storage device used in conjunction with the memory storage device.

In some embodiments, a computer program product is described comprising a computer usable medium having control logic (computer software program, including program code) stored therein. The control logic, when executed by the processor of the computer, causes the processor to perform functions described herein. In other embodiments, some functions are implemented primarily in hardware using, for example, a hardware state machine. Implementation of the hardware state machine so as to perform the functions described herein will be apparent to those skilled in the relevant arts.

Memory may be any suitable device in which the one or more general purpose processors as well as the plurality of parallel processing units, such as a graphics processor, can store and retrieve data, such as magnetic, optical, or solid-state storage devices (including magnetic or optical disks or tape or RAM, or any other suitable device, either fixed or portable). The general purpose processor may include a general-purpose digital microprocessor suitably programmed from a computer readable medium carrying necessary program code. The parallel processing units may include one or more graphics processors suitably programmed from a computer readable medium carrying necessary program code. Programming can be provided remotely to the processors through one or more communication channels, or previously saved in a computer program product such as memory or some other portable or fixed computer readable storage medium using any of those devices in connection with memory. For example, a magnetic or optical disk may carry the programming, and can be read by a disk writer/reader. Systems of the invention also include programming, e.g., in the form of computer program products, algorithms for use in practicing the methods as described above. Programming according to the present invention can be recorded on computer readable media, e.g., any medium that can be read and accessed directly by a computer. Such media include, but are not limited to: magnetic storage media, such as floppy discs, hard disc storage medium, and magnetic tape; optical storage media such as CD-ROM; electrical storage media such as RAM and ROM; portable flash drive; and hybrids of these categories such as magnetic/optical storage media.

The one or more general purpose processors may also have access to a communication channel to communicate with a user at a remote location. By remote location is meant the user is not directly in contact with the system and relays input information to an input manager from an external device, such as a computer connected to a Wide Area Network (“WAN”), telephone network, satellite network, or any other suitable communication channel, including a mobile telephone (i.e., smartphone).

In some embodiments, systems according to the present disclosure may be configured to include a communication interface. In some embodiments, the communication interface includes a receiver and/or transmitter for communicating with a network and/or another device. The communication interface can be configured for wired or wireless communication, including, but not limited to, radio frequency (RF) communication (e.g., Radio-Frequency Identification (RFID), Zigbee communication protocols, WiFi, infrared, wireless Universal Serial Bus (USB), Ultra-Wide Band (UWB), Bluetooth® communication protocols, and cellular communication, such as code division multiple access (CDMA) or Global System for Mobile communications (GSM).

In one embodiment, the communication interface is configured to include one or more communication ports, e.g., physical ports or interfaces such as a USB port, an RS-232 port, or any other suitable electrical connection port to allow data communication between the subject systems and other external devices such as a computer terminal (for example, at a physician's office or in hospital environment) that is configured for similar complementary data communication.

In one embodiment, the communication interface is configured for infrared communication, Bluetooth® communication, or any other suitable wireless communication protocol to enable the subject systems to communicate with other devices such as computer terminals and/or networks, communication enabled mobile telephones, personal digital assistants, or any other communication devices which the user may use in conjunction.

In one embodiment, the communication interface is configured to provide a connection for data transfer utilizing Internet Protocol (IP) through a cell phone network, Short Message Service (SMS), wireless connection to a personal computer (PC) on a Local Area Network (LAN) which is connected to the internet, or WiFi connection to the internet at a WiFi hotspot.

In one embodiment, the subject systems are configured to wirelessly communicate with a server device via the communication interface, e.g., using a common standard such as 802.11 or Bluetooth® RF protocol, or an IrDA infrared protocol. The server device may be another portable device, such as a smart phone, Personal Digital Assistant (PDA) or notebook computer; or a larger device such as a desktop computer, appliance, etc. In some embodiments, the server device has a display, such as a liquid crystal display (LCD), as well as an input device, such as buttons, a keyboard, mouse or touch-screen.

In some embodiments, the communication interface is configured to automatically or semi-automatically communicate data stored in the subject systems, e.g., in an optional data storage unit, with a network or server device using one or more of the communication protocols and/or mechanisms described above.

Output controllers may include controllers for any of a variety of known display devices for presenting information to a user, whether a human or a machine, whether local or remote. If one of the display devices provides visual information, this information typically may be logically and/or physically organized as an array of picture elements. A graphical user interface (GUI) controller may include any of a variety of known or future software programs for providing graphical input and output interfaces between the system and a user, and for processing user inputs. The functional elements of the computer may communicate with each other via a system bus. Some of these communications may be accomplished in alternative embodiments using network or other types of remote communications. The output manager may also provide information generated by the processing module to a user at a remote location, e.g., over the Internet, phone or satellite network, in accordance with known techniques. The presentation of data by the output manager may be implemented in accordance with a variety of known techniques. As some examples, data may include SQL, HTML or XML documents, email or other files, or data in other forms. The data may include Internet URL addresses so that a user may retrieve additional SQL, HTML, XML, or other documents or data from remote sources. The one or more platforms present in the subject systems may be any type of known computer platform or a type to be developed in the future, although they typically will be of a class of computer commonly referred to as servers. However, they may also be a main-frame computer, a work station, or other computer type. They may be connected via any known or future type of cabling or other communication system including wireless systems, either networked or otherwise. They may be co-located, or they may be physically separated. Various operating systems may be employed on any of the computer platforms, possibly depending on the type and/or make of computer platform chosen. Appropriate operating systems include Windows 10, Windows NTD, Windows XP, Windows 7, Windows 8, iOS, Oracle Solaris, Linux, OS/400, Compaq Tru64 Unix, SGI IRIX, Siemens Reliant Unix, Ubuntu, Zorin OS and others.

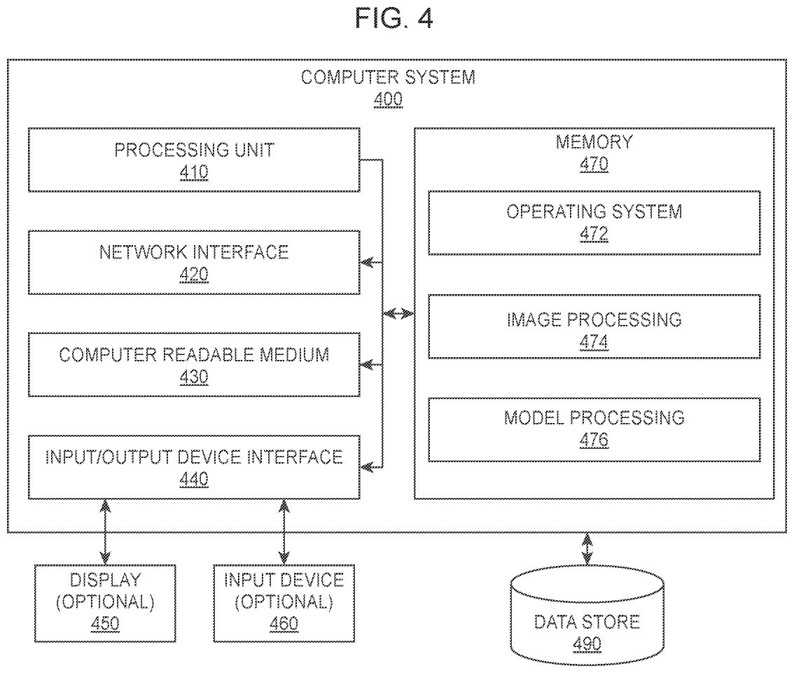

FIG. 4 depicts a general architecture of an example computing device 400 according to certain embodiments. The general architecture of the computing device 400 depicted in FIG. 4 includes an arrangement of computer hardware and software components. The computing device 400 may include many more (or fewer) elements than those shown in FIG. 4. It is not necessary, however, that all of these generally conventional elements be shown in order to provide an enabling disclosure. As illustrated, the computing device 400 includes a processing unit 410, a network interface 420, a computer readable medium drive 430, an input/output device interface 440, a display 450, and an input device 460, all of which may communicate with one another by way of a communication bus. The network interface 420 may provide connectivity to one or more networks or computing systems. The processing unit 410 may thus receive information and instructions from other computing systems or services via a network. The processing unit 410 may also communicate to and from memory 470 and further provide output information for an optional display 450 via the input/output device interface 440. The input/output device interface 440 may also accept input from the optional input device 460, such as a keyboard, mouse, digital pen, microphone, touch screen, gesture recognition system, voice recognition system, gamepad, accelerometer, gyroscope, or other input device.

The memory 470 may contain computer program instructions (grouped as modules or components in some embodiments) that the processing unit 410 executes in order to implement one or more embodiments. The memory 470 generally includes RAM, ROM and/or other persistent, auxiliary or non-transitory computer-readable media. The memory 470 may store an operating system 472 that provides computer program instructions for use by processing unit 410 in the general administration and operation of the computing device 400. The memory 470 may further include computer program instructions and other information for implementing aspects of the present disclosure.

For example, in one embodiment, the memory 470 includes an image processing module 474 for modulating one or more aspects of a cytometric data image as well as a model processing module 476 for applying a model to estimate the presence of a particle belonging to a first category of particles in the cytometric image data.

### Computer-Readable Storage Mediums

Aspects of the present disclosure further include non-transitory computer readable storage mediums having instructions for practicing the subject methods. Computer readable storage mediums may be employed on one or more computers for complete automation or partial automation of a system for practicing methods described herein. In certain embodiments, instructions in accordance with the method described herein can be coded onto a computer-readable medium in the form of “programming,” where the term “computer readable medium” as used herein refers to any non-transitory storage medium that participates in providing instructions and data to a computer for execution and processing. Examples of suitable non-transitory storage media include a floppy disk, hard disk, optical disk, magneto-optical disk, CD-ROM, CD-R, magnetic tape, non-volatile memory card, ROM, DVD-ROM, Blue-ray disk, solid state disk, and network attached storage (NAS), whether or not such devices are internal or external to the computer. A file containing information can be “stored” on a computer readable medium, where “storing” means recording information such that it is accessible and retrievable at a later date by a computer. The computer-implemented method described herein can be executed using programming that can be written in one or more of any number of computer programming languages. Such languages include, for example, Java (Sun Microsystems, Inc., Santa Clara, CA), Visual Basic (Microsoft Corp., Redmond, WA), C++ (AT&T Corp., Bedminster, NJ), Python, as well as any many others.

In some embodiments, computer readable storage media of interest include a computer program stored thereon, where the computer program when loaded on the computer includes instructions having: algorithm for receiving unclassified cytometric image data, wherein the cytometric image data comprises a plurality of images corresponding to image channels, and algorithm for iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data.

### Utility

The subject systems, methods and non-transitory computer readable storage mediums find use in a variety of applications where it is desirable to identify or analyze or classify particles, such as cells, in a sample, such as a biological sample. In embodiments, the systems and methods described herein find use in imaging flow cytometry characterization of biological samples, including where the sample is labeled with fluorescent tags. In addition, the subject systems and methods find use in analyzing or classifying particles of a sample, such as by identifying categories or classifications of particles not previously known to be present in the sample. Further, the subject systems and methods find use in analyzing or classifying particles of a sample based on additional information such as cytometric imaging data corresponding to image features or characteristics across different image channels. As a result, in some cases, the subject systems and methods may find use in distinguishing different particle types in a sample, such as different cell types in a biological sample.

The following is offered by way of illustration and not by way of limitation.

### Experimental

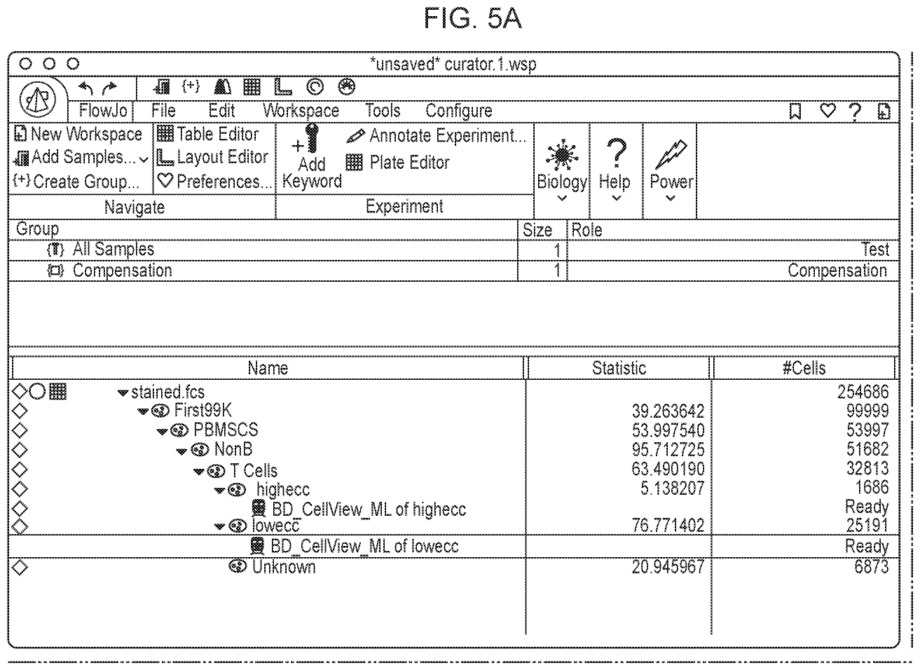

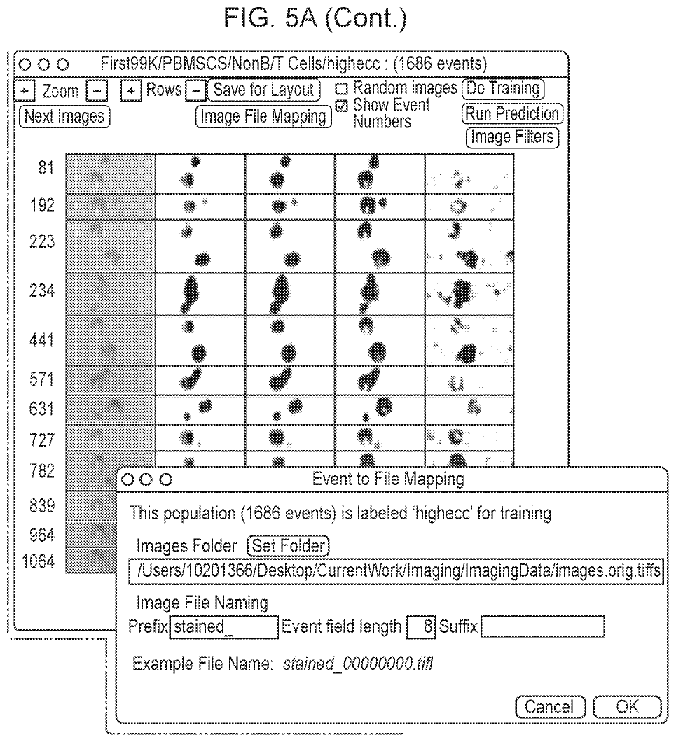

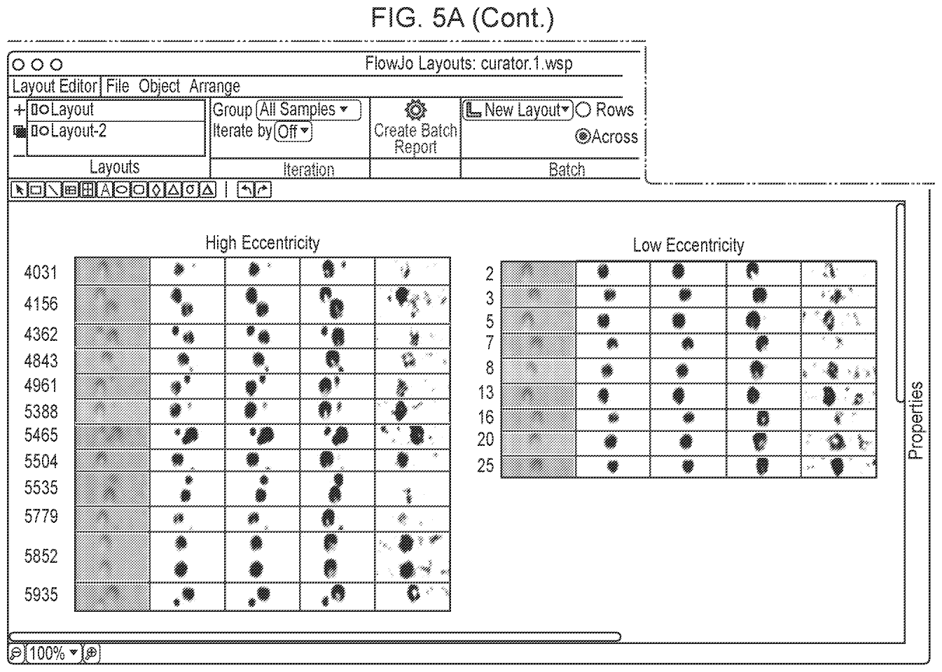

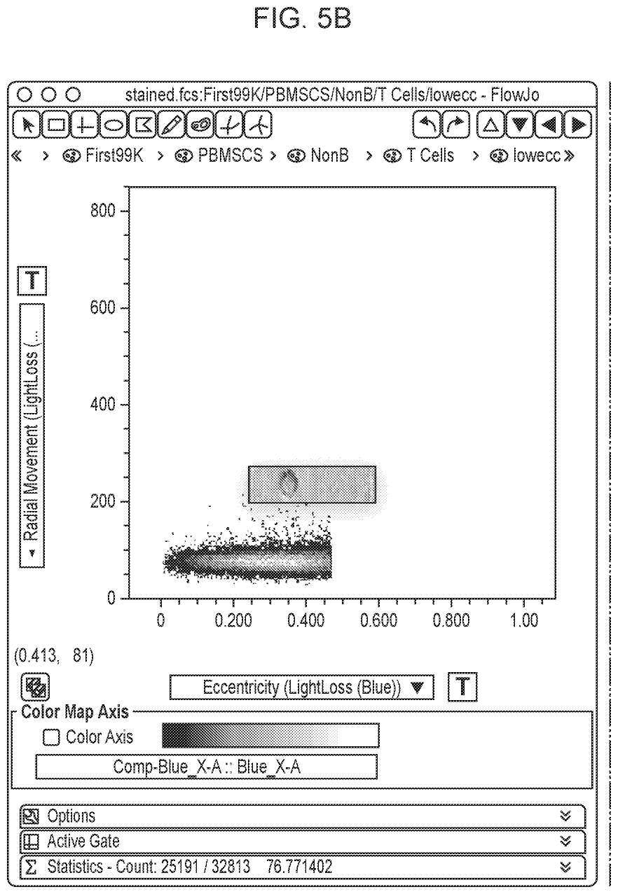

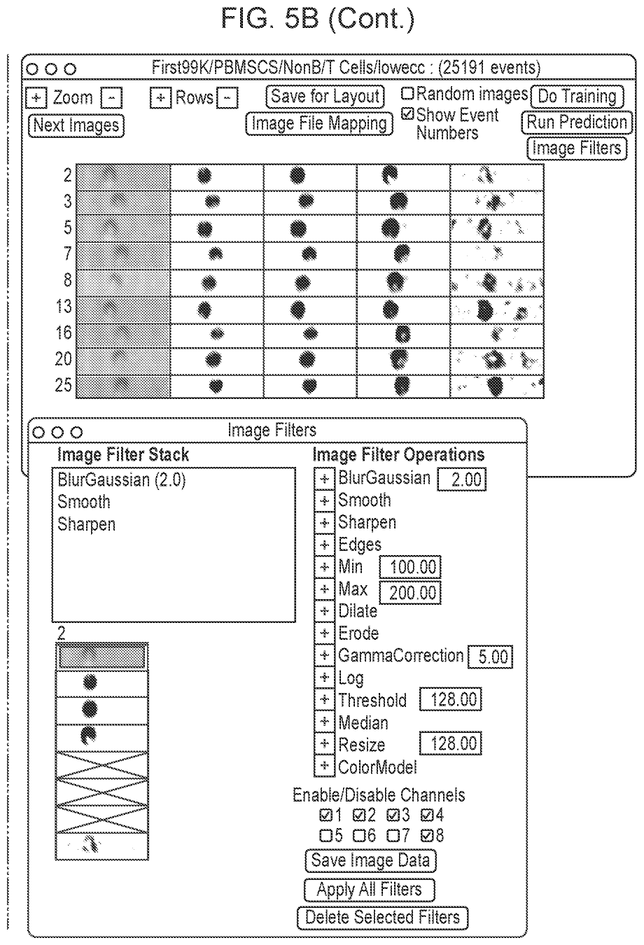

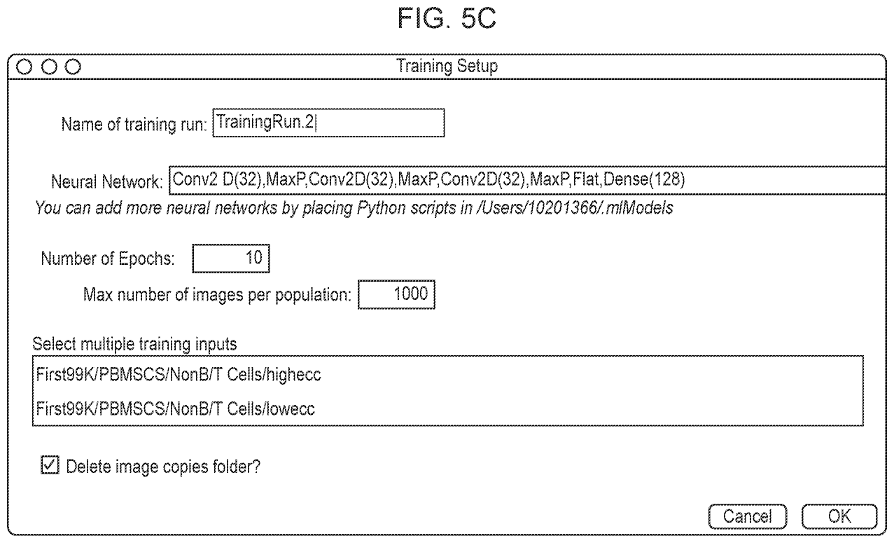

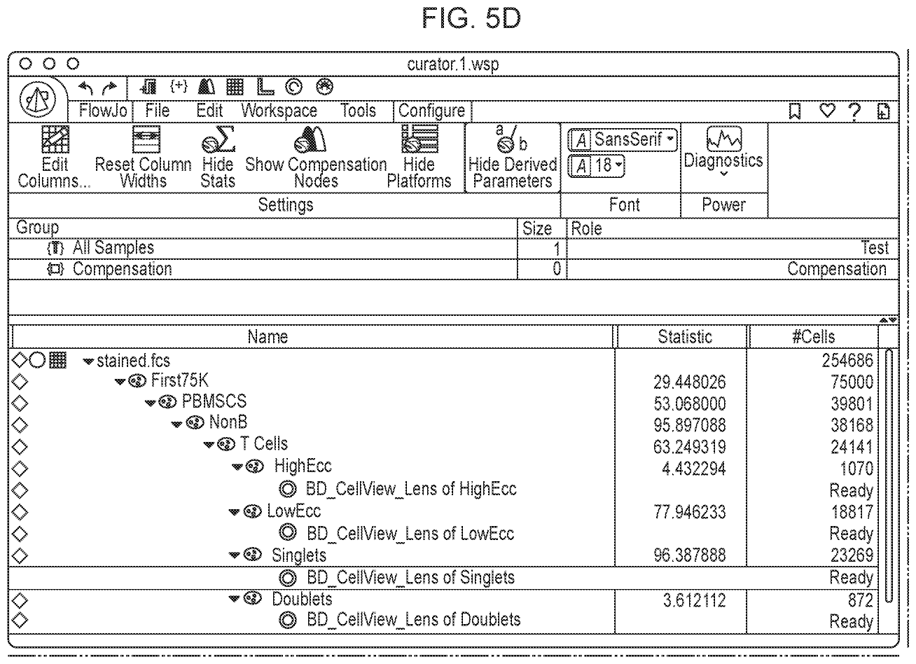

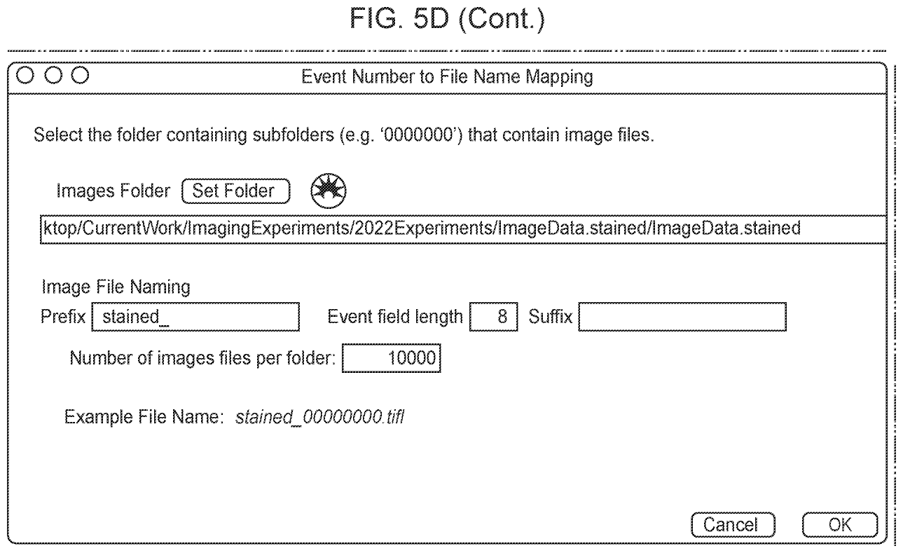

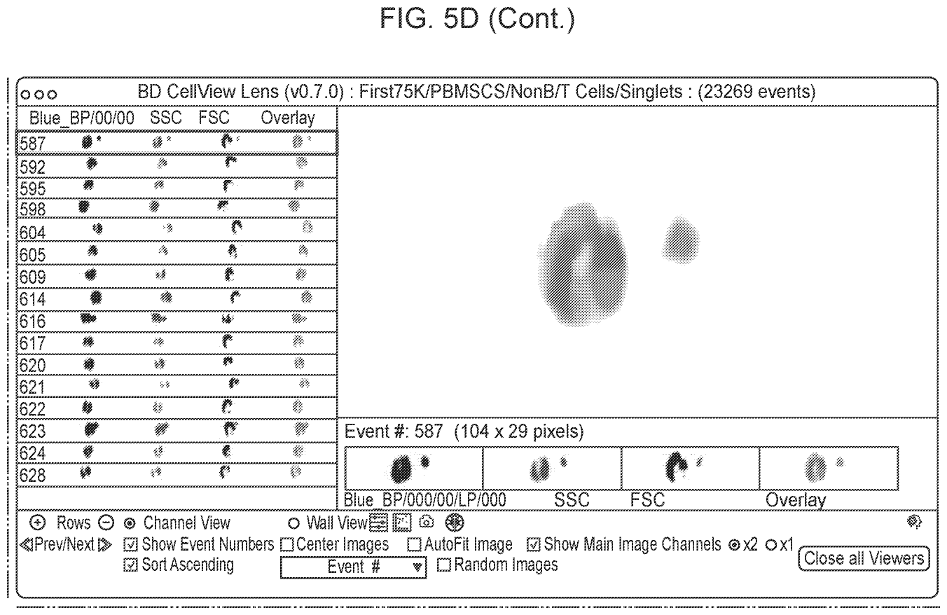

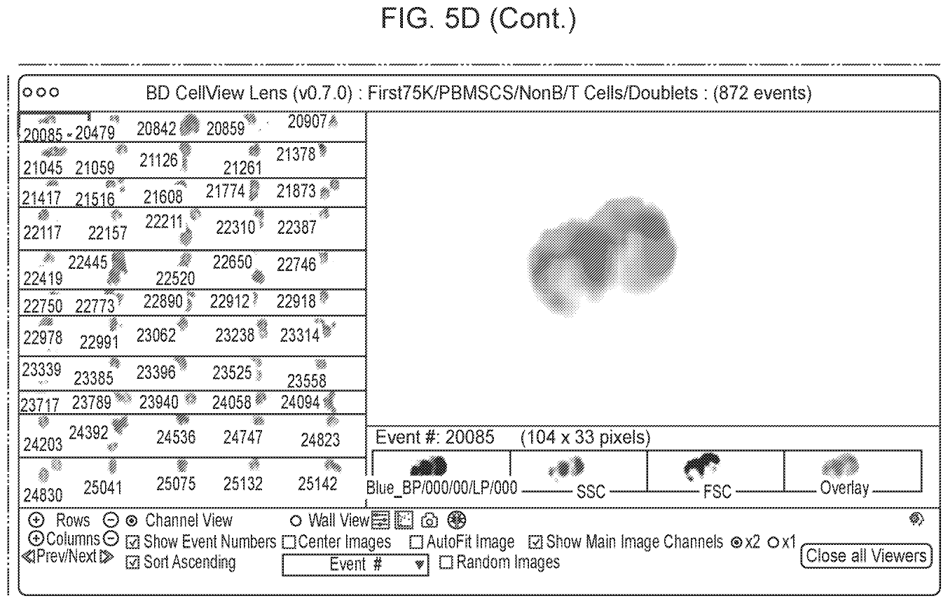

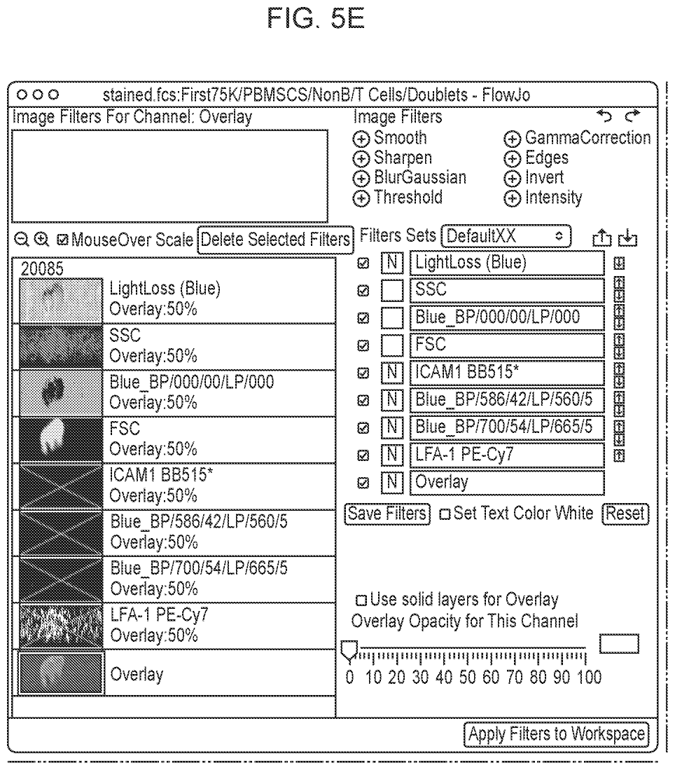

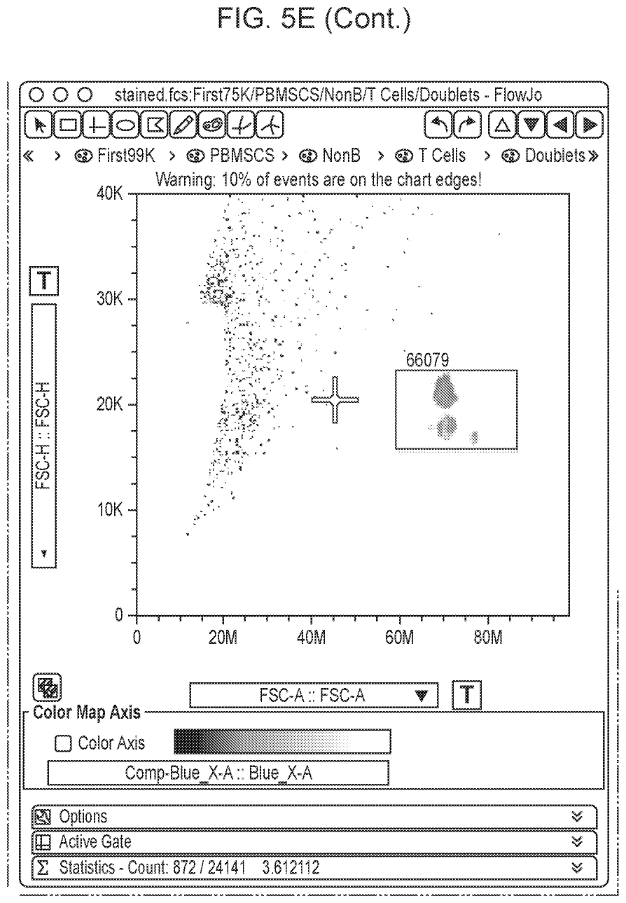

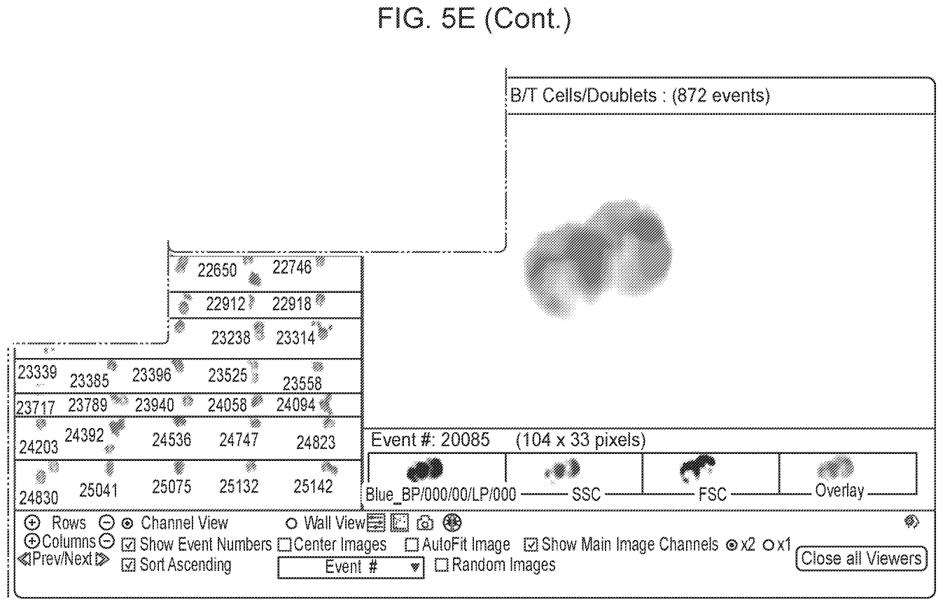

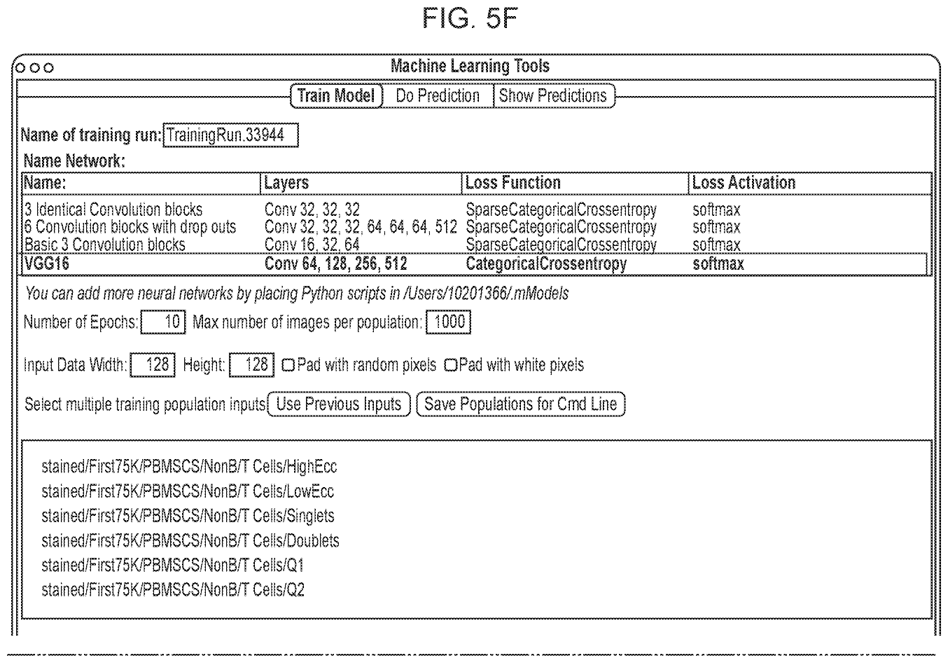

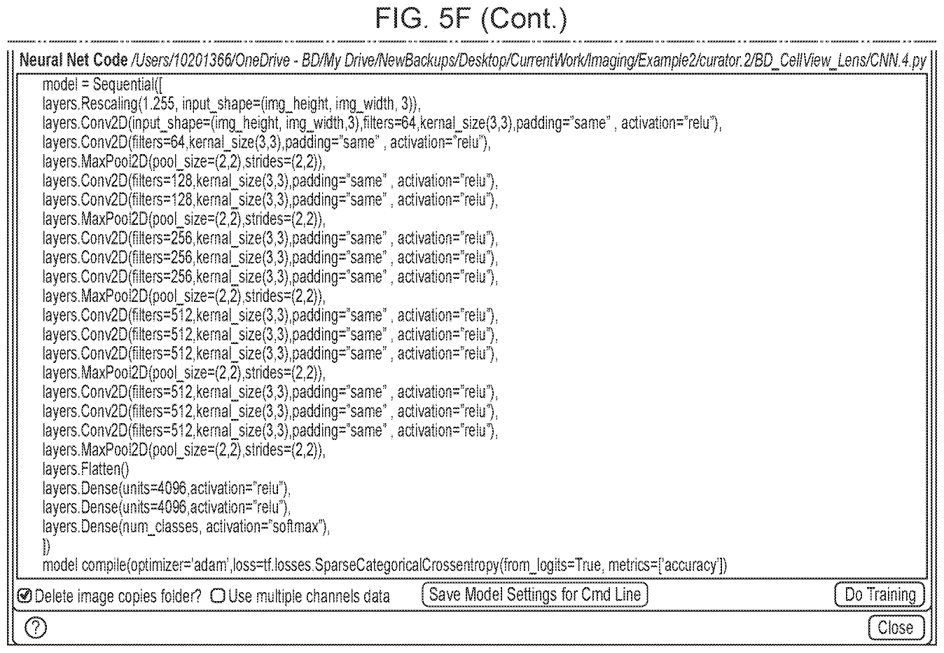

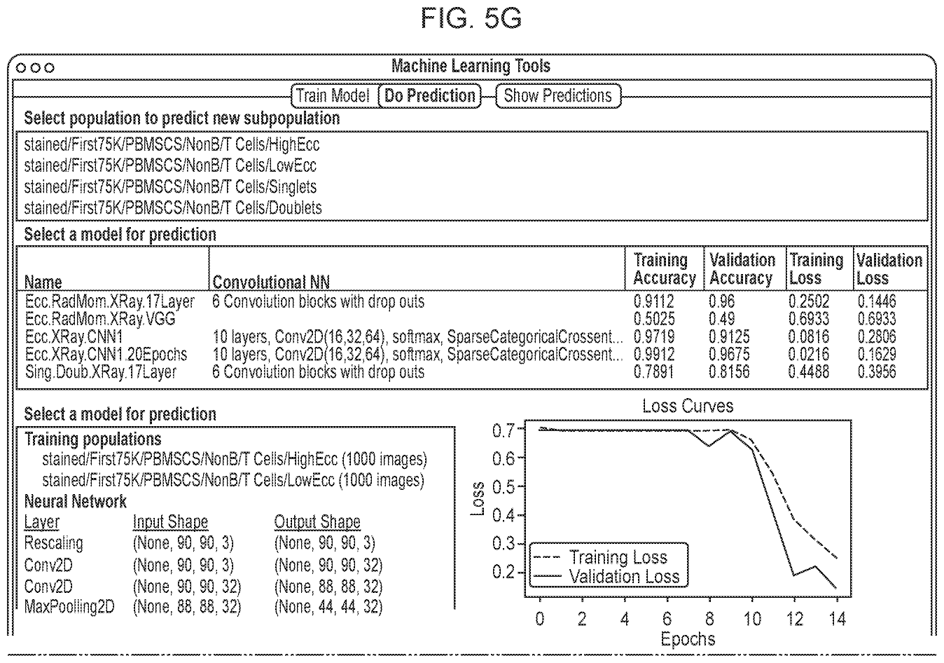

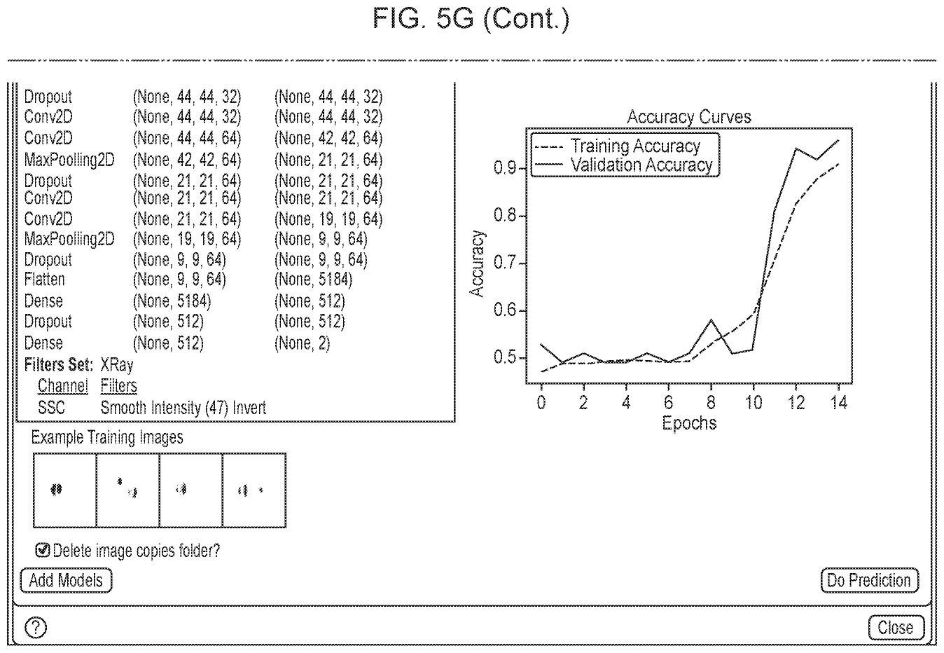

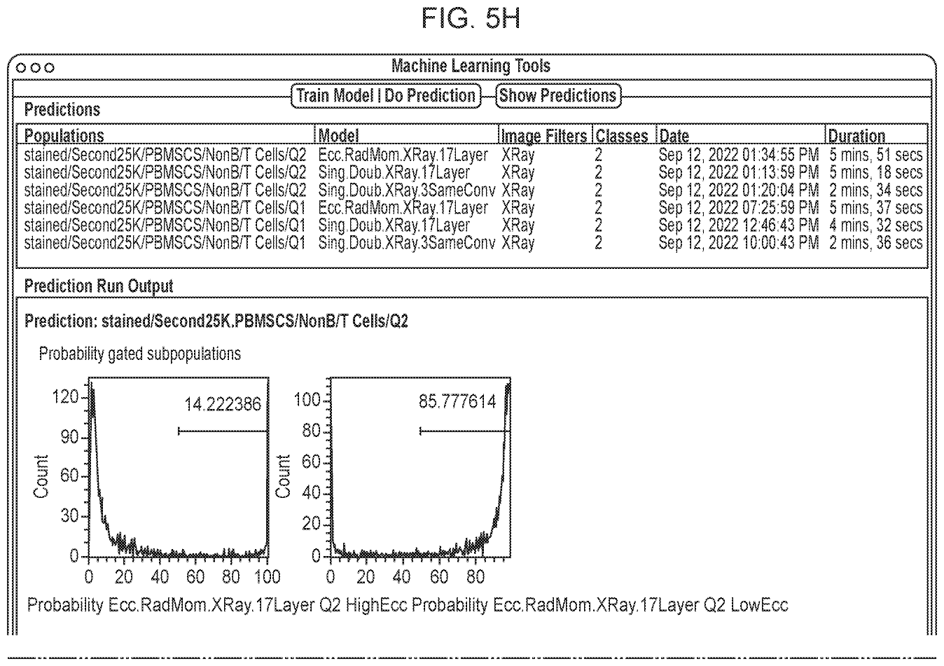

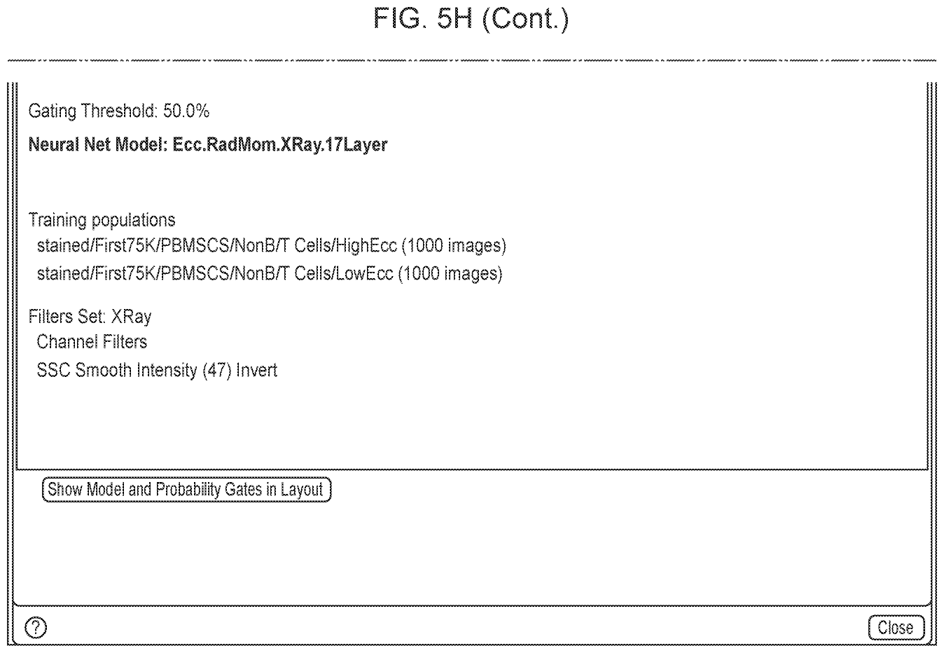

FIGS. 5A-H depict excerpts from an embodiment of a computer implementation of a method according to the present invention.

FIG. 5A depicts an excerpt of a user interface of such embodiment with images of subpopulations of particles. FIG. 5B depicts an excerpt of a user interface for creating image filter stacks per channel and exploring aspects thereof in the graph window with a mouse. FIG. 5C depicts an excerpt of a user interface for invoking a neural network on training populations.

FIG. 5D depicts an excerpt of an alternative user interface of such embodiment with images of subpopulations of particles and how the association of events to image files may be specified. FIG. 5E depicts an excerpt of such alternative user interface for creating multiple image filters per channel and exploring aspects thereof in the graph window with a mouse. FIG. 5F depicts an excerpt of such alternative user interface for invoking a neural network on training populations by selecting the training populations, a neural network and configuring hyperparameters. FIG. 5G depicts an excerpt of such alternative user interface for selecting populations to classify and inspecting the accuracy and example images of an existing model. FIG. 5H depicts an excerpt of such alternative user interface for browsing the results of classifying populations using neural network models.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112(f) or 35 U.S.C. § 112(6) is not invoked.

1. A method of classifying cytometric image data, the method comprising:
receiving unclassified cytometric image data, wherein the cytometric image data comprises a plurality of images corresponding to image channels; and
iteratively modulating aspects of at least one image of the plurality of images of the cytometric image data and applying a model to the modulated cytometric image data to classify the cytometric image data, wherein the model is trained to estimate the presence of a particle belonging to a first category of particles in the cytometric image data.

2. The method according to claim 1, wherein applying the model to cytometric image data to classify the cytometric image data comprises obtaining an estimate of the presence of a particle belonging to the first category of particles in the cytometric image data.

3. The method according to claim 2, wherein applying the model to cytometric image data further comprises obtaining a confidence score associated with the estimate of the presence of a particle belonging to the first category of particles in the cytometric image data.

4. The method according to claim 3, wherein iteratively modulating aspects of at least one image of the plurality of images of the unclassified cytometric image data and applying the model to the modulated image data comprises obtaining a plurality of estimates and confidence scores, wherein each estimate and confidence score corresponds to each iteration of applying the model.

5. The method according to claim 3, wherein a higher confidence score corresponds to a greater likelihood that the estimate of the presence of a particle belonging to the first category of particles in the cytometric image data is accurate.

6. The method according to claim 3, wherein a lower confidence score corresponds to a lower likelihood that the estimate of the presence of a particle belonging to the first category of particles in the cytometric image data is accurate.

7. The method according to claim 3, wherein iteratively modulating aspects of at least one image and applying the model to the modulated cytometric image data comprises iteratively:
applying an image modulation operation to the at least one image of the plurality of images of the cytometric image data;
applying the model to the unclassified cytometric image data comprising at least one modulated image;
obtaining a confidence score as a result of applying the model; and
comparing the confidence score to a reference confidence score.

8. The method according to claim 7, wherein the reference confidence score comprises a confidence score corresponding to applying the model to the unclassified cytometric image data without any image modulation.

9. The method according to claim 7, further comprising determining a subsequent image modulation operation based on the results of comparing the confidence score to the reference confidence score.

10. The method according to claim 3, wherein iteratively modulating aspects of at least one image and applying the model to the modulated image data comprises repeatedly iterating to improve the accuracy of the estimate of the presence of a particle belonging to the first category of particles in the cytometric image data.

11. The method according to claim 10, wherein iteratively modulating aspects of at least one image and applying the model to the modulated image data comprises repeatedly iterating to improve the confidence score associated with each estimate of the presence of a particle belonging to the first category of particles in the cytometric image data.

12. The method according to claim 11, wherein iteratively modulating aspects of at least one image and applying the model to the modulated image data comprises modulating aspects of at least one image to optimize the confidence score associated with each estimate of the presence of a particle belonging to the first category of particles in the cytometric image data.

13. The method according to claim 12, wherein optimizing the confidence score associated with each estimate of the presence of a particle belonging to the first category of particles in the cytometric image data comprises finding a local maximum of the confidence score.

14. The method according to claim 1, wherein the method comprises iteratively modulating a plurality of aspects of a first image of the plurality of images of the cytometric image data and applying the model to the modulated image data.

15. (canceled)

16. The method according to claim 1, wherein iteratively modulating aspects of at least one image and applying the model to the modulated image data comprises applying a simulated annealing technique.

17-21. (canceled)

22. The method according to any of the previous claims, further comprising identifying modulated image data corresponding to an estimate of the presence of a particle belonging to a first category of particles in the cytometric image data.

23-28. (canceled)

29. The method according to claim 1, further comprising updating the model based on the results of iteratively applying the model to the modulated image data.

30-38. (canceled)

39. The method according to claim 1, wherein the model was trained to estimate the presence of a particle belonging to a first category of particles in the cytometric image data using one or more of: an unsupervised learning technique, a semi-supervised learning technique, a supervised learning technique or a round robin training technique.

40-42. (canceled)

43. The method according to claim 1, further comprising normalizing aspects of the cytometric image data.

44-177. (canceled)
